(19) United States
(12) Patent Application Publication
(10) Pub. No.: US 2001/0051916 A1
(43) Pub. Date: Dec. 13, 2001

(54) Server device, terminal device, application communication system, application communication method and recording medium for recording application communication program, for proper communication of application divided into portions

(76) Inventors: Masashi Shiomi, Soraku-gun (JP); Yoshikazu Nishiura, Nara-shi (JP); Masayuki Ehiro, Osaka (JP); Junichi Tanimoto, Ikoma-shi (JP); Teruaki Morita, Kitakatsuragi-gun (JP)

Correspondence Address: BIRCH STEWART KOLASCH & BIRCH, PO BOX 747, FALLS CHURCH, VA, 22040-0747, US

(21) Appl. No.: 09/864,355

(22) Filed: May 25, 2001

(30) Foreign Application Priority Data
May 26, 2000 (JP) 2000-156750(P)
Sep. 13, 2000 (JP) 2000-278155(P)

(51) Int. Cl. G06F 17/60

(52) U.S. Cl. 705/39

(57) ABSTRACT

The server device includes a first storage unit that stores an application divided into sub-applications, a second storage unit that stores information for each sub-application; a third storage unit that stores user information, a fourth storage unit that stores prepayment information, and a control unit that controls the entire server device. Some of the sub-applications can be executed alone. The control unit receives a send request from a user, and sends the sub-application through a data communication path. The user terminal which received the sub-application can start execution thereof immediately. Thus, an application communication system allowing utilization of a desired application in a short period of time after the start of communication is provided.

### BACKGROUND OF THE INVENTION

1. Field of the Invention

The present invention relates to server devices, terminal devices, application communication systems, application communication methods and recording mediums for recording application communication programs. More particularly, the present invention relates to a server device, a terminal device, an application communication system and an application communication method for communicating an application divided into several portions through a data communication path, and a recording medium recording an application communication program for such communication.

2. Description of the Background Art

In recent years, networks such as the Internet have become widespread rapidly. Corresponding thereto, various kinds of applications including game software and data of books in digital forms have increasingly been downloaded from server devices to client terminals through such networks.

A data distribution method generally in use attempts to reduce the burdens imposed on communication infrastructures as well as receiver sides by compressing the data to be communicated so as to reduce its capacity. However, in the case where an application to be distributed has a lot of capacity and just compressing thereof is insufficient, another distribution method as follows is usually employed.

In this distribution method, one application is divided into a plurality of units of, e.g., the capacity of floppy disk drive (FDD), and the application is distributed to a user in such units. The user receives and installs the units of application successively into his/her terminal device. When installation of all the units is completed, the units are combined and operated as one application.

For an unstable communication infrastructure such as a mobile terminal, a packet communication system is known as such a distribution method. The packet communication system attempts to suppress communication errors and reduce the traffic load by dividing the data to be distributed into units of packet. The data in these packets are combined on the terminal side, and utilized as one set of data (one application).

The application distribution system as described above, however, has a disadvantage that it takes a long period of time from the time when the communication is started till the time when the application is ready for use by the user.

More specifically, the user cannot operate the application until the entire application is completely installed or stored in a storage device. Especially, for communication of an application of a large volume, the user should wait for a very long period of time after he/she issues the send request until the desired application becomes ultimately available.

Thus, in the case where immediacy is required, i.e., when the user wants to execute an application such as game software as soon as possible, this method is extremely inconvenient.

In addition, an entire application should be received even if a user wants to use only a portion thereof, which is again inconvenient.

Further, in the case of mobile communication, the communication conditions depend on the topography during the communication, the distance from the base station and others, so that it is difficult to always keep a good communication condition. Thus, it has been extremely difficult to send or receive an application of a large capacity stably over a long period of time.

Accordingly, with the conventional distribution method requiring all the divided units corresponding to one application to be received completely before becoming available in the user terminal, the utilization of application itself has been difficult.

In addition, with the conventional distribution method, there has been a problem related to a method (charging method) of demanding payment of the price of the application. In the conventional distribution method, payment has been made on the premise that all the units of application are transferred completely. Thus, the user had to pay for the entire application even if he/she needed only a portion thereof.

### SUMMARY OF THE INVENTION

Based on the foregoing, an object of the present invention is to provide a server device, a terminal device, an application communication system, an application communication method and a computer readable recording medium recording an application communication program that enable utilization of a desired application in a short period of time after a start of communication thereof.

Another object of the present invention is to provide a server device, a terminal device, an application communication system, an application communication method and a computer readable recording medium recording an application communication program that can promote utilization of application communication.

The above objects of the present invention are achieved by a server device provided with the following elements. According to an aspect of the present invention, a server device includes: a first storage unit that stores an application divided into a plurality of portions, or sub-applications; a receiving unit that receives information from a user; and a sending unit that sends at least one of the sub-applications according to the received information. At least one of the sub-applications is executable alone.

Preferably, the sending unit sends the sub-application executable alone in the first place.

Preferably, the sub-applications have their order for execution, and an object of the application before being divided is achieved by executing the sub-applications in the order.

Here, the application refers to any kind of programs (contents) for execution of a certain process, which includes game software, continuous data of novel, movie, drama or music, and others. Although simple collection of data that are unrelated to each other is not included in the application of this definition, collection of data required for realization of a certain object is included therein.

According to these inventions, at least one of the sub-applications is sent to a user according to information received from the user. The sub-applications have their order for execution, and an object of the application before being divided can be achieved by executing the sub-applications in the order. At least one of the sub-applications can be executed alone.

Accordingly, the user who received the sub-application is allowed to execute the received sub-application even if the entire application is not received. Thus, a server device that allows utilization of a desired application in a short time period after the start of communication is provided.

Preferably, the first storage unit stores the sub-applications by relating them with IDs (Identifications) for identification thereof.

According to the invention, the IDs related to the sub-applications for identification thereof are stored. This enables easy identification of each sub-application.

Preferably, the sub-applications each include the ID of the sub-application that is supposed to be utilized next.

According to the invention, the ID of the sub-application that is expected to be used next is included in each sub-application. Thus, the order for execution of the sub-applications is readily extracted.

Preferably, at least one of the sub-applications includes the ID that identifies that it is the last sub-application.

According to the invention, the ID identifying that the sub-application is the last one is included in the sub-application. This allows notification of completion of execution of one application.

Preferably, when the receiving unit receives the ID of a sub-application, the sending unit sends, based on the received ID, the relevant sub-application stored in the first storage unit.

According to the invention, when the ID of a sub-application is received from a user, the relevant sub-application is sent to the user. Thus, a desired sub-application can be sent to a user appropriately.

Preferably, the server device is further provided with a second storage unit that stores prescribed information for each sub-application.

According to the invention, prescribed information is stored for each sub-application, which can be utilized when necessary.

Preferably, the prescribed information includes the ID of each sub-application and price information corresponding thereto.

According to the invention, the application ID and the corresponding price information are stored. Thus, it becomes possible to know the price for each sub-application.

Preferably, the price information corresponding to a sub-application that is to be sent in the second or later place is lower than the price information corresponding to a sub-application that is being sent in the first place.

According to the invention, the sub-application to be sent in the second or later place is lower in price than the sub-application being sent in the first place. Thus, it is possible to give the user who received the sub-application sent in the first place an incentive to buy or utilize the following sub-application(s).

Preferably, the prescribed information includes the number of times of utilization of each sub-application.

According to the invention, the number of times of utilization of each sub-application is stored, and thus, it is possible to know how frequently each sub-application has been utilized.

Preferably, the server device is further provided with a fifth storage unit that stores information of a discount rate corresponding to the number of times of utilization.

According to the invention, the information of the discount rate corresponding to the number of times of utilization is stored, which can be utilized when necessary.

Preferably, the server device is further provided with a setting unit that sets the price of sub-application that is expected to be utilized next, based on the number of times of utilization of a prescribed sub-application that is stored in the second storage unit and the discount rate corresponding to the relevant number of times of utilization that is stored in the fifth storage unit.

According to the invention, the discount rate is determined according to the frequency of utilization of a prescribed sub-application, and the price of the sub-application to be used next is set based on the determined discount rate. Thus, it is possible to arouse the user's incentive to buy the next sub-application.

Preferably, the server device is further provided with a setting unit that sets the price of sub-application that is to be sent in the second or later place, based on the number of times of utilization of the sub-application sent in the first place that is stored in the second storage unit and the discount rate corresponding to the relevant number of times of utilization that is stored in the fifth storage unit.

According to the invention, the discount rate is determined according to the frequency of utilization of the sub-application sent in the first place, and the price of the sub-application being sent in the second or later place is set based on the determined discount rate. Accordingly, it is possible to stimulate the user's incentive to buy the sub-application(s) following the first sub-application.

Preferably, the prescribed information includes information about presence/absence of advertisement.

According to the invention, the information about presence/absence of advertisement is stored for each sub-application. Therefore, it is possible to know whether the advertisement is present/absent for a certain sub-application when necessary.

Preferably, when a sub-application for which the information about presence/absence of advertisement indicates that the advertisement exists is to be sent, the sending unit sends the sub-application with corresponding advertisement data attached thereto.

According to the invention, when there exists advertisement information for a sub-application, the relevant advertisement information is sent attached to the sub-application. Thus, it is possible to notify a user of desired advertisement information.

Preferably, the prescribed information includes an application name corresponding to the sub-application.

According to the invention, it is possible to readily know the application name of the sub-application.

Preferably, the server device is further provided with a third storage unit that stores user information.

According to the invention, the user information is stored, which can be utilized when necessary.

Preferably, the user information includes user ID and password for identification of a user.

According to the invention, the user ID and password are stored, which can be utilized when identifying the user.

Preferably, the server device is further provided with a first determination unit that determines, when the receiving unit receives user ID and password, whether the received user ID and password match the user ID and password stored in the third storage unit.

According to the invention, determination is made as to whether user ID and password received from a user match those stored. Thus, it is possible to identify whether the user is an authorized user.

Preferably, the server device is further provided with a prohibition unit that prohibits a sending operation of the sending unit when the first determination unit determines that the user IDs and passwords do not match.

According to the invention, the application sending operation is not performed when the user ID and password received from the user do not match those stored. Therefore, the application is sent exclusively to an authorized user, which improves reliability.

Preferably, the user information includes an application utilization history.

According to the invention, the history of utilization of application by a user is stored. Thus, it is possible to obtain appropriate information about the user from applications utilized in the past or the like.

Preferably, the server device is further provided with an extract unit that extracts appropriate advertisement data stored in the first storage unit based on the stored utilization history, and an advertisement data sending unit that sends the advertisement data extracted.

According to the invention, appropriate advertisement information is sent to a user based on the user's utilization history. Thus, the user is able to obtain appropriate information.

Preferably, the user information includes credit balance information of a user.

According to the invention, the credit balance information concerning payment made by the user is stored, and therefore, falsification of the credit balance by the user becomes impossible. The credit balance information can be retrieved when necessary.

Preferably, the server device is further provided with a comparison unit that compares the credit balance information of a user and the price information for a sub-application required by the user. According to the comparison result of the comparison unit, the sending unit sends the relevant sub-application only in the case where the credit balance information is greater than or equal to the price information.

According to the invention, the user receives the desired sub-application only when the credit balance of the user covers the price of the desired sub-application. Therefore, it is possible to apply financial brakes to the user.

Preferably, the server device is further provided with a fourth storage unit that stores prepayment information.

According to the invention, the prepayment information concerning payment made in advance is stored, which enables settlement by cable.

Preferably, the prepayment information includes prepaid ID and password.

According to the invention, the prepaid ID and password are stored, which can be utilized for verification of a prepaid card and the like.

Preferably, the server device is further provided with a second determination unit that determines, when the receiving unit receives prepaid ID and password, whether the received prepaid ID and password match the prepaid ID and password stored in the fourth storage unit.

According to the invention, it is possible to make a proper decision as to whether the received prepaid ID and password are correct.

Preferably, the prepayment information includes value information.

According to the invention, the value information of a medium such as a prepaid card is stored in the server device. Thus, tampering of the value information becomes impossible.

Preferably, the server device is further provided with a charging unit that charges a user a price of the sub-application every time the sending unit sends the sub-application to the user.

According to the invention, the user is charged on the basis of sub-application. Thus, the user is able to utilize a necessary application at a minimum price. Accordingly, it becomes possible to provide a server device that can promote utilization of application communication by allowing an appropriate price to be charged.

Preferably, the server device is further provided with a confirmation unit that confirms whether sending of the sub-application by the sending unit is completed. The charging unit charges for the sub-application when the confirmation unit confirms that the sending is completed.

According to the invention, the user is charged only when sending of the sub-application is completed. This avoids the situation where payment is demanded even though the communication was interrupted and ended incomplete.

According to another aspect of the present invention, a server device includes: a first storage unit that stores an application divided into a plurality of sub-applications; a receiving unit that receives information from a user; a sending unit that sends at least one of the sub-applications according to the received information; and a charging unit that charges a user a price of the sub-application every time the sending unit sends the sub-application to the user.

According to the invention, every time the sub-application is sent to a user, the user who received the sub-application is charged for the sub-application. Thus, the user only needs to pay a minimum price. Accordingly, a server device that can promote utilization of application communication by allowing a reasonable price to be charged is provided.

Preferably, the server device is further provided with a confirmation unit that confirms whether sending of a sub-application by the sending unit is completed. The charging unit charges for the sub-application when the confirmation unit confirms completion of the sending.

According to the invention, the user is charged only when the sub-application is sent completely. Thus, the situation where payment is demanded even though the communication was interrupted and ended incomplete is avoided.

Preferably, the server device is further provided with a second storage unit that stores user ID and password for identification of a user; a determination unit that determines, when the receiving unit receives user ID and password, whether the received user ID and password match the user ID and password stored in the second storage unit; and a prohibition unit that prohibits a sending operation of the sending unit when the determination unit determines that the user IDs and passwords mismatch.

According to the invention, determination is made as to whether user ID and password input by a user match those stored. When they mismatch, the application sending operation is not performed. Thus, the application is sent only to an authorized user, thereby improving reliability.

Preferably, the second storage unit further stores credit balance information of a user. The sending unit sends the sub-application required by the user when the credit balance information of the user is greater than or equal to the price information of the relevant sub-application.

According to the invention, a user is able to receive a desired sub-application only when the credit balance of the user covers the price of the relevant sub-application. Thus, it is possible to apply financial brakes to the user.

According to a further aspect of the present invention, a terminal device includes: a receiving unit that receives a sub-application as a portion of a divided application; an execution unit that executes the sub-application received; and a request unit that issues a send request for a next sub-application according to a result of execution by the execution unit, based on information about the sub-application to be utilized next that is stored in the received sub-application.

According to the invention, a send request for a next sub-application is issued according to a result of execution of the sub-application, based on the information of sub-application to be utilized next that is stored in the executed sub-application. Thus, the sub-applications can be received in an appropriate order.

Preferably, when advertisement data corresponding to a sub-application is sent along with the sub-application, the receiving unit receives the advertisement data as well.

According to the invention, a user can receive, in addition to the desired application, interesting advertisement data related thereto.

Preferably, the terminal device is further provided with a sending unit that sends a reception complete signal when a receiving operation of sub-application of the receiving unit is completed.

According to the invention, a complete signal is sent upon completion of reception of the sub-application. Thus, whether the reception is completed or not can be notified appropriately.

According to a still further aspect of the present invention, an application communication system consists of: a server device provided with a sending unit that sends a sub-application executable alone; and a terminal device that receives the relevant sub-application.

According to the invention, the server device that received an application send request from the terminal sends the sub-application executable alone to the terminal. Thus, the terminal device can execute the sub-application immediately upon receipt thereof. Accordingly, an application communication system that allows utilization of a desired application in a short period of time after a start of communication can be provided.

According to yet another aspect of the present invention, an application communication system consists of: a server device provided with a charging unit that charges every time a sub-application is sent; and a terminal device that receives the sub-application.

According to the invention, a user is charged for each sub-application, so that the application can be utilized at a minimum price. Accordingly, an application communication system that can promote utilization of application communication by charging an appropriate price is provided.

According to a still further aspect of the present invention, an application communication method includes: a first storing step of storing an application divided into a plurality of sub-applications; a receiving step of receiving information from a user; and a sending step of sending at least one of the sub-applications according to the received information. At least one of the sub-applications can be executed alone.

Preferably, the sending step sends the sub-application executable alone in the first place.

According to these inventions, it becomes possible to provide an application communication method that allows utilization of a desired application in a short period of time after a start of communication.

Preferably, the sub-applications have their order for execution, and an object of the application before being divided is achieved by executing the sub-applications in the order.

Preferably, the first storing step stores the sub-applications by relating them with IDs for identification thereof.

Preferably, the sub-applications each include the ID of the sub-application that is expected to be utilized next.

Preferably, at least one of the sub-applications includes the ID that identifies that the relevant sub-application is the last one.

Preferably, when the ID of a sub-application is received in the receiving step, the sending step sends, based on the received ID, the relevant sub-application stored in the first storing step.

Preferably, the application communication method is further provided with a second storing step of storing prescribed information for each sub-application.

Preferably, the prescribed information includes the ID of the sub-application and price information corresponding thereto.

Preferably, the price information corresponding to the sub-application that is to be sent in the second or later place is lower than the price information corresponding to the sub-application that is being sent in the first place.

Preferably, the prescribed information includes the number of times of utilization of sub-application.

Preferably, the application communication method is further provided with a fifth storing step of storing information of a discount rate corresponding to the number of times of utilization.

Preferably, the application communication method is further provided with a setting step of setting a price of the sub-application that is to be sent next, based on the number of times of utilization of a prescribed sub-application that is stored in the second storing step and the discount rate corresponding to the relevant number of times of utilization that is stored in the fifth storing step.

Preferably, the application communication method is further provided with a setting step of setting a price of the sub-application that is to be sent in the second or later place, based on the number of times of utilization of the sub-application sent in the first place that is stored in the second storing step and the discount rate corresponding to the relevant number of times of utilization that is stored in the fifth storing step.

Preferably, the prescribed information includes information about presence/absence of advertisement.

Preferably, when a sub-application for which the information indicates the presence of the advertisement is to be sent, the sending step sends the relevant sub-application with corresponding advertisement data attached thereto.

Preferably, the prescribed information includes an application name corresponding to the sub-application.

Preferably, the application communication method is further provided with a third storing step of storing user information.

Preferably, the user information includes user ID and password for identification of a user.

Preferably, the application communication method is further provided with a first determining step of determining, when user ID and password are received in the receiving step, whether the received user ID and password match the user ID and password stored in the third storing step.

Preferably, the application communication method is further provided with a prohibiting step of prohibiting a sending operation by the sending step when mismatch of the user IDs and passwords is determined in the first determination step.

Preferably, the user information includes an application utilization history.

Preferably, the application communication method is further provided with an extracting step of extracting appropriate advertisement data stored in the first storing step based on the stored utilization history, and an advertisement data sending step of sending the extracted advertisement data.

Preferably, the user information includes credit balance information of a user.

Preferably, the application communication method is further provided with a comparing step of comparing the credit balance information of a user with price information of sub-application required by the user. As a result of comparison, if the credit balance information is greater than or equal to the price information, the sending step sends the sub-application.

Preferably, the application communication method is further provided with a fourth storing step of storing prepayment information.

Preferably, the prepayment information includes prepaid ID and password.

Preferably, the application communication method is further provided with a second determining step of determining, when prepaid ID and password are received in the receiving step, whether the received prepaid ID and password match the prepaid ID and password stored in the fourth storing step.

Preferably, the prepayment information includes value information.

Preferably, the application communication method is further provided with a charging step of charging a user a price of the sub-application every time the sub-application is sent to the user.

Preferably, the application communication method is further provided with a confirming step of confirming whether sending of the sub-application in the sending step is completed. The charging step charges for the sub-application when completion of the sending is confirmed by the confirming step.

According to a still further aspect of the present invention, an application communication method includes: a first storing step of storing an application divided into a plurality of sub-applications; a receiving step of receiving information from a user; a sending step of sending at least one of the sub-applications according to the received information; and a charging step of charging a user a price of the sub-application every time the sub-application is sent to the user.

According to the invention, it is possible to provide an application communication method that can promote utilization of application communication by allowing a reasonable price to be charged.

Preferably, the application communication method is further provided with a confirming step of confirming whether sending of the sub-application is completed in the sending step. The charging step charges for the sub-application when completion of the sending is confirmed by the confirming step.

Preferably, the application communication method is further provided with a second storing step of storing user ID and password for identification of a user; a determining step of determining, when user ID and password are received in the receiving step, whether the received user ID and password match the user ID and password stored in the second storing step; and a prohibiting step of prohibiting a sending operation of the sending step when mismatch of the user IDs and passwords is determined in the determining step.

Preferably, the second storing step further stores credit balance information of a user, and the sending step sends a sub-application required by the user when the credit balance information of the user is greater than or equal to the price information of the relevant sub-application.

According to yet another aspect of the present invention, an application communication method includes: a receiving step of receiving a sub-application as a portion of a divided application; an executing step of executing the received sub-application; and a requesting step of issuing a send request for a next sub-application according to a result of execution by the executing step, based on the information of sub-application to be utilized next that is stored in the received sub-application.

According to the invention, as a result of execution of the sub-application, based on the information of sub-application to be used next that is stored in the executed sub-application, a send request for the next sub-application is issued. Therefore, an application communication method that can receive sub-applications in an appropriate order is realized.

Preferably, the application communication method is further provided with a sending step of sending a reception complete signal when a receiving operation of the sub-application in the receiving step is completed.

According to a further aspect of the present invention, an application communication method performs application communication using a server device provided with a sending unit that sends a sub-application executable alone, and a terminal device that receives the sub-application.

According to the invention, the server device which received an application send request from a terminal device sends a sub-application that is executable alone to the terminal device. The terminal device which received the sub-application can execute the sub-application immediately. Accordingly, it is possible to provide an application communication method that allows utilization of a desired application in a short period of time after a start of communication.

According to a still further aspect of the present invention, an application communication method performs application communication using a server device provided with a charging unit that charges every time a sub-application is sent, and a terminal device that receives the sub-application.

According to the invention, payment is demanded on the basis of sub-application, and thus, the application can be utilized at a minimum price. Accordingly, it is possible to provide an application communication method that can promote utilization of application communication by allowing an appropriate price to be charged.

According to yet another aspect of the present invention, a computer readable recording medium records an application communication program for causing a computer to execute an application communication method. The application communication method includes: a first storing step of storing an application divided into a plurality of sub-applications; a receiving step of receiving information from a user; and a sending step of sending at least one of the sub-applications according to the received information. At least one of the sub-applications can be executed alone.

Preferably, the sending step sends the sub-application executable alone in the first place.

According to these inventions, it is possible to provide a recording medium recording an application communication program for causing a computer to execute an application communication method that allows utilization of a desired application in a short period of time after a start of communication.

Preferably, the sub-applications have their order for execution, and an object of the application before being divided can be achieved by executing the sub-applications in the order.

Preferably, the first storing step stores the sub-applications by relating them with IDs for identification thereof.

Preferably, the sub-applications each include the ID of sub-application that is expected to be utilized next.

Preferably, at least one of the sub-applications includes the ID that identifies that the relevant sub-application is the last one.

Preferably, when the ID of sub-application is received in the receiving step, the sending step sends, based on the received ID, the relevant sub-application stored in the first storing step.

Preferably, the application communication method is further provided with a second storing step of storing prescribed information for each sub-application.

Preferably, the prescribed information includes the ID of sub-application and price information corresponding thereto.

Preferably, the price information corresponding to the sub-application that is to be sent in the second or later place is lower than the price information corresponding to the sub-application that is being sent in the first place.

Preferably, the prescribed information includes the number of times of utilization of sub-application.

Preferably, the application communication method is further provided with a fifth storing step of storing information of a discount rate corresponding to the number of times of utilization.

Preferably, the application communication method is further provided with a setting step of setting a price of the sub-application that is to be sent next, based on the number of times of utilization of a prescribed sub-application that is stored in the second storing step and the discount rate corresponding to the relevant number of times of utilization that is stored in the fifth storing step.

Preferably, the application communication method is further provided with a setting step of setting a price of the sub-application that is to be sent in the second or later place, based on the number of times of utilization of the sub-application sent in the first place that is stored in the second storing step and the discount rate corresponding to the relevant number of times of utilization that is stored in the fifth storing step.

Preferably, the prescribed information includes information about presence/absence of advertisement.

Preferably, when a sub-application for which the information indicates the presence of the advertisement is to be sent, the sending step sends the relevant sub-application with corresponding advertisement data attached thereto.

Preferably, the prescribed information includes an application name corresponding to the sub-application.

Preferably, the application communication method is further provided with a third storing step of storing user information.

Preferably, the user information includes user ID and password for identification of a user.

Preferably, the application communication method is further provided with a first determining step of determining, when user ID and password are received in the receiving step, whether the received user ID and password match the user ID and password stored in the third storing step.

Preferably, the application communication method is further provided with a prohibiting step of prohibiting a sending operation by the sending step when mismatch of the user IDs and passwords is determined in the first determining step.

Preferably, the user information includes an application utilization history.

Preferably, the application communication method is further provided with an extracting step of extracting, based on the stored utilization history, appropriate advertisement data stored in the first storing step, and an advertisement data sending step of sending the extracted advertisement data.

Preferably, the user information includes credit balance information of a user.

Preferably, the application communication method is further provided with a comparing step of comparing the credit balance information of a user and the price information of sub-application required by the user. As a result of comparison by the comparing step, if the credit balance information is greater than or equal to the price information, the sending step sends the relevant sub-application to the user.

Preferably, the application communication method is further provided with a fourth storing step of storing prepayment information.

Preferably, the prepayment information includes prepaid ID and password.

Preferably, the application communication method is further provided with a second determining step of determining, when prepaid ID and password are received in the receiving step, whether the received prepaid ID and password match the prepaid ID and password stored in the fourth storing step.

Preferably, the prepayment information includes value information.

Preferably, the application communication method is further provided with a charging step of charging a user a price of the sub-application every time the sub-application is sent to the user.

Preferably, the application communication method is further provided with a confirming step of confirming whether sending of the sub-application in the sending step is completed. The charging step charges for the sub-application when completion of the sending is confirmed by the confirming step.

According to a further aspect of the present invention, a computer readable recording medium records an application communication program for causing a computer to execute an application communication method. The application communication method includes: a first storing step of storing an application divided into a plurality of sub-applications; a receiving step of receiving information from a user; a sending step of sending at least one of the sub-applications according to the received information; and a charging step of charging a user a price of the sub-application every time the sub-application is sent to the user in the sending step.

According to the invention, it is possible to provide a computer readable recording medium recording an application communication program for causing a computer to execute an application communication method that can promote utilization of application communication by allowing an appropriate price to be charged.

Preferably, the application communication method is further provided with a confirming step of confirming whether sending of the sub-application by the sending step is completed. The charging step charges for the sub-application when completion of the sending is confirmed by the confirming step.

Preferably, the application communication method is further provided with: a second storing step of storing user ID and password for identification of a user; a determining step of determining, when user ID and password are received in the receiving step, whether the received user ID and password match the user ID and password stored in the second storing step; and a prohibiting step of prohibiting a sending operation by the sending step when mismatch of the user IDs and passwords is determined in the determining step.

Preferably, the second storing step further stores credit balance information of a user, and the sending step sends a sub-application required by a user when the credit balance information of the user is greater than or equal to the price information of the relevant sub-application.

According to a still further aspect of the present invention, a computer readable recording medium records an application communication program for causing a computer to execute an application communication method. The application communication method includes: a receiving step of receiving a sub-application as a portion of a divided application; an executing step of executing the received sub-application; and a requesting step of issuing a send request for a next sub-application according to a result of execution in the executing step, based on the information of sub-application to be utilized next that is stored in the received sub-application.

According to the invention, as a result of execution of the sub-application, based on the information of sub-application to be utilized next that is stored in the executed sub-application, a next send request is issued. Accordingly, it is possible to provide a computer readable recording medium recording an application communication program for causing a computer to execute an application communication method that allows reception of sub-applications in a proper order.

Preferably, the application communication method is further provided with a sending step of sending a reception complete signal when the receiving operation of sub-application in the receiving step is completed.

According to yet another aspect of the present invention, a computer readable recording medium records an application communication program for causing a computer to execute an application communication method. The application communication method performs application communication using a server device provided with a sending unit that sends a sub-application executable alone, and a terminal device that receives the sub-application.

According to the invention, the server device which received an application send request from the terminal device sends the sub-application executable alone to the terminal device. The terminal device which received the sub-application can execute the sub-application immediately. Accordingly, it is possible to provide a computer readable recording medium recording an application communication program with which a computer can execute an application communication method that allows utilization of a desired application in a short period of time after a start of communication.

According to a further aspect of the present invention, a computer readable recording medium records an application communication program for causing a computer to execute an application communication method. The application communication method performs communication of application using a server device provided with a charging unit that charges for a sub-application every time the sub-application is sent, and a terminal device that receives the sub-application.

According to the invention, a price is charged for each sub-application, and therefore, the application can be utilized at a minimum price. Accordingly, it is possible to provide a computer readable recording medium recording an application communication program with which a computer can execute an application communication method that can promote utilization of application communication by allowing an appropriate price to be charged.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 illustrates a concept of an entire application communication system according to a first embodiment of the present invention.

FIG. 2 shows a detailed configuration of the server system in FIG. 1.

FIGS. 3-6 show examples of data stored in the first, second, third and fourth storage units, respectively.

FIG. 7 is a block diagram showing a schematic configuration of the mobile terminal.

FIG. 8 is a flow chart illustrating an operation flow of the entire application communication system according to the first embodiment of the present invention.

FIG. 9 shows an example of a prepaid card to be purchased.

FIG. 10 is a flow chart illustrating a sub-routine for the prepaid card purchasing process (step S803) in FIG. 8.

FIG. 11 is a flow chart illustrating a sub-routine for the terminal authentication process (step S805) in FIG. 8.

FIG. 12 is a flow chart illustrating a sub-routine for the application select process (step S807) in FIG. 8.

FIG. 13 is a flow chart illustrating a sub-routine for the application sending and charging process (step S1207) in FIG. 12.

FIG. 14 is a flow chart illustrating a sub-routine for the prepayment process (step S1321) in FIG. 13.

FIG. 15 is a flow chart illustrating a sub-routine for the application execution process (step S809) in FIG. 8.

FIG. 16 shows a configuration of a golf game to be communicated.

FIG. 17 shows an example of data stored in the second storage unit according to a first modification of the first embodiment.

FIG. 18 shows an example of data stored in the fifth storage unit.

FIG. 19 shows an example of data stored in the second storage unit according to a second embodiment of the present invention.

FIG. 20 shows an example of data stored in the first storage unit of the second embodiment.

FIG. 21 is a flow chart illustrating the operation flow for the application sending and charging process (step S1207 in FIG. 12) according to the second embodiment.

### DESCRIPTION OF THE PREFERRED EMBODIMENTS

Hereinafter, embodiments of the present invention will be described with reference to the drawings.

(1) First Embodiment

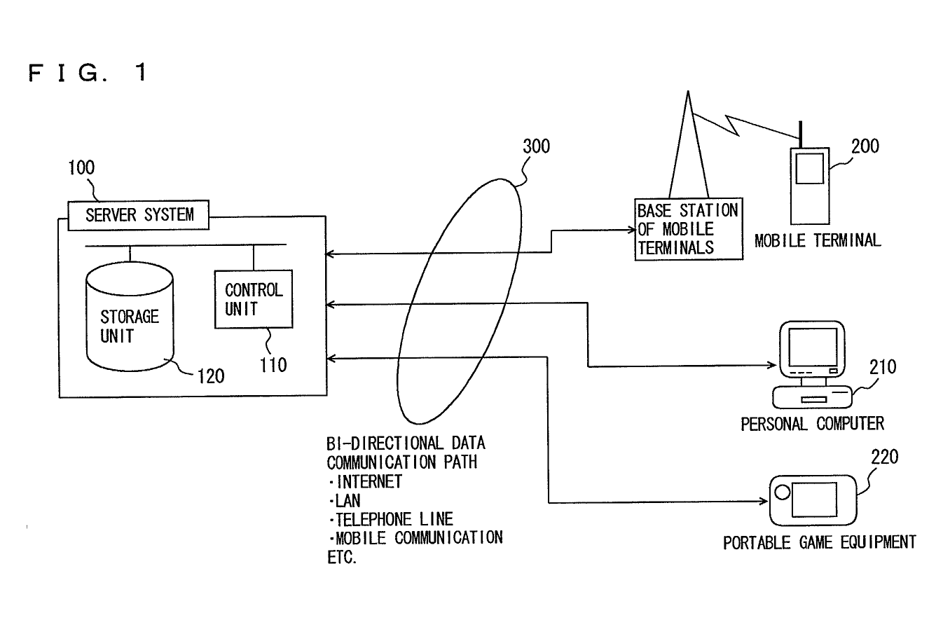

Referring to FIG. 1, the application communication system consists of a server system 100 and a plurality of terminal devices 200, 210 and 220 (hereinafter, also referred to as “terminals”). Server system 100 and terminal devices 200, 210 and 220 can communicate with each other through a data communication path 300.

Server system 100 includes: a storage unit 120 that stores information about an application divided into a plurality of portions, information about users (user information), information about advance payment (prepayment information) and others; and a control unit 110 that controls the entire server system 100. Throughout the specification, each of the portions of the divided application is referred to as a “sub-application”.

Terminal device 200 is a mobile terminal that performs data communication through a base station for mobile terminals. Terminal device 210 is a personal computer. Terminal device 220 is portable game equipment.

Data communication path 300 allows communication in both directions, for which the Internet, LAN (Local Area Network), a telephone line, a mobile communication and others are utilized.

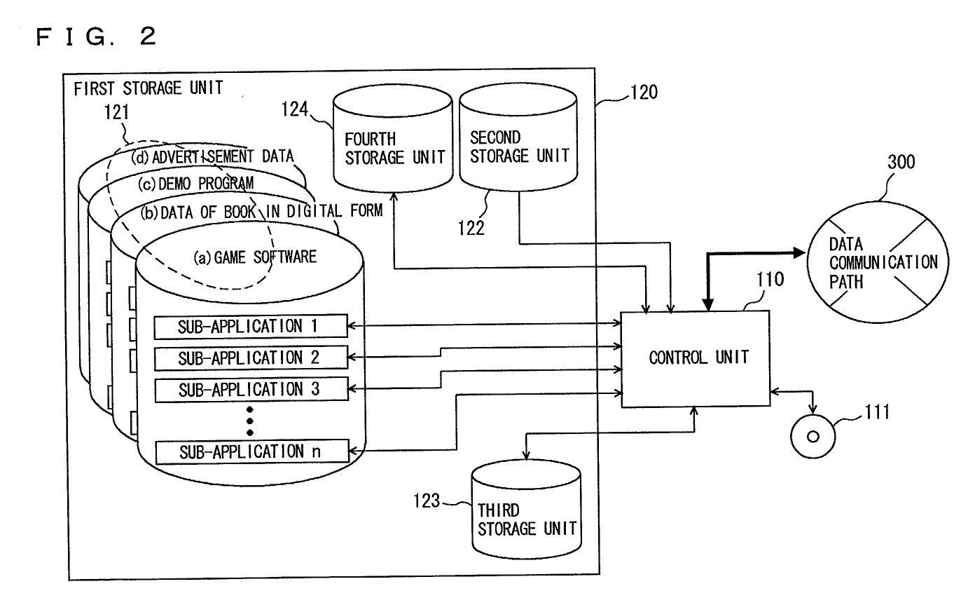

Now, server system 100 will be described with reference to FIGS. 2-6.

FIG. 2 shows a detailed configuration of server system 100 in FIG. 1. Referring to FIG. 2, server system 100 includes control unit 110 and storage unit 120, as described above.

Storage unit 120 includes: a first storage unit 121 that stores applications each divided into sub-applications; a second storage unit 122 that stores information of the respective sub-applications; a third storage unit 123 that stores user information; and a fourth storage unit 124 that stores prepayment information.

First storage unit 121 stores a plurality of applications including game software (a), data of a book in a digital form (b), a demonstration (demo) program (c), advertisement data (d), and others. Each application is divided into minimum units according to its contents. For example, game software (a) is divided into n portions, or n sub-applications, according to the contents of the game. Communication of the application is performed in a unit of sub-application.

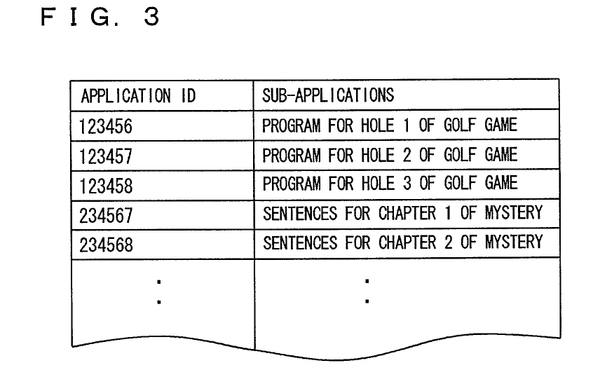

FIG. 3 shows exemplary data stored in first storage unit 121. Referring to FIG. 3, first storage unit 121 stores an application divided into a plurality of sub-applications, and application IDs for identification of the respective sub-applications.

For example, one application of golf game titled “Super Golf” is divided into several portions, such as “Program for Hole 1 of Golf Game”, “Program for Hole 2 of Golf Game” and “Program for Hole 3 of Golf Game”, which are stored as its sub-applications. These sub-applications are related to application IDs 123456, 123457 and 123458, respectively, which are also stored in first storage unit 121.

Each application ID contains information for classification including categories, e.g., game software, book data in a digital form, demo program, and advertisement data.

Here, each sub-application includes the application ID of sub-application that is supposed to be utilized next. For example, in “Program for Hole 1 of Golf Game”, application ID (123457) of “Program for Hole 2 of Golf Game” that is expected to be used next is included.

If there is no sub-application that should be utilized next, the sub-application includes the application ID indicating that the relevant sub-application is the last sub-application.

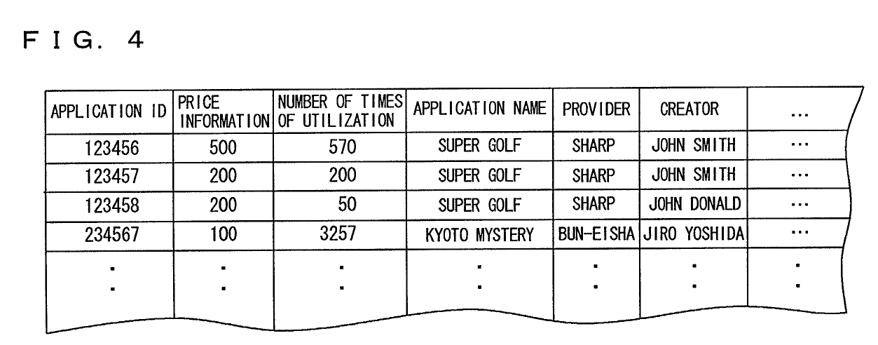

Second storage unit 122 stores information about the sub-applications. FIG. 4 shows exemplary data stored in second storage unit 122. Referring to FIG. 4, second storage unit 122 stores various kinds of information associated with respective sub-applications, which are related to corresponding application IDs. The information includes, e.g., price information, number of times of utilization, application name, names of provider and creator of each sub-application.

For example, stored for the sub-application of “Program for Hole 1 of Golf Game” (application ID=123456) are: 500 yen as its price, 570 as the accumulated number of times of its utilization, “Super Golf” as the application name, “Sharp” as the name of provider, and “John Smith” as the name of creator, which are related to the application ID.

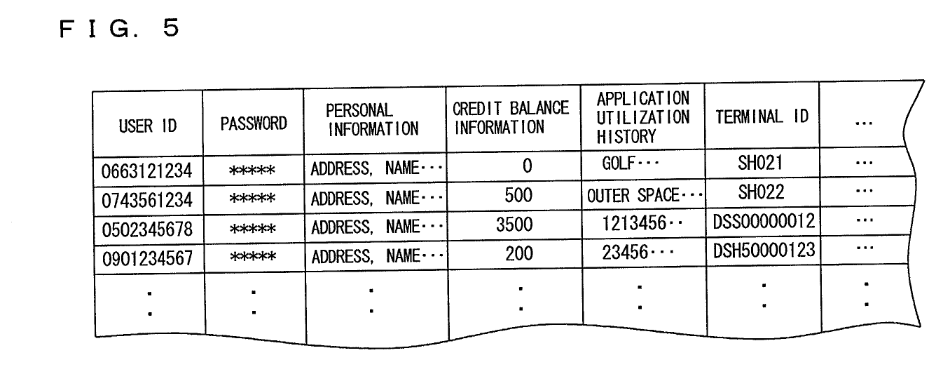

Third storage unit 123 stores personal information of users who utilize the application communication system. FIG. 5 shows exemplary data stored in third storage unit 123. Referring to FIG. 5, third storage unit 123 stores, for each user, personal information including his/her password, address, name, age and occupation, credit balance information of the user, application utilization history information indicating application(s) having been used by the user, terminal ID for identification of his/her terminal and others, which are related to the relevant user ID.

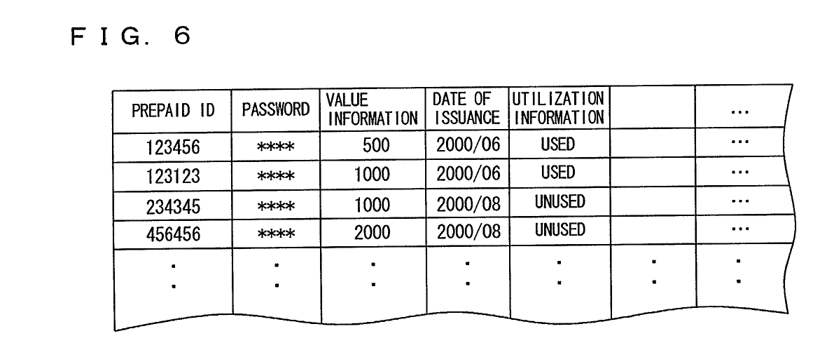

Fourth storage unit 124 stores prepayment information. FIG. 6 shows exemplary data stored in fourth storage unit 124. Referring to FIG. 6, fourth storage unit 124 stores, for each prepaid card, a prepaid ID for identification of the prepaid card, a password of the prepaid card, value information, date of issuance, utilization information and others, which are related to the relevant prepaid ID.

Specifically, the prepaid ID, the password and the value information of a prepaid card are predetermined as the prepayment information at the time when it is manufactured or sold. As the utilization information, either “used” or “unused” is recorded according to whether a user has used the relevant prepaid card.

When the card is “used” by a user, the value information corresponding to the relevant prepaid ID is added to the credit balance information of the relevant user shown in FIG. 5.

Returning to FIG. 2, control unit 110 is composed of a central processing unit, a temporary storage device, a data communication path connection device and a main program storage unit, which are not shown in the drawing.

The central processing unit performs control of respective units, selection and transfer of data, temporary storage of information and others, according to a main program stored in the main program storage unit.

The temporary storage device temporarily stores processed results of the central processing unit.

The data communication path connection device connects server system 100 to data communication path 300, and communicates with terminal devices 200, 210 and 220 in both directions via data communication path 300.

The main program stored in the main program storage unit is a program for implementation of the application communication system, which controls the entire server system 100. It includes a plurality of programs.

Specifically, the main program includes: a program for displaying at a terminal side a guiding image plane to let a user select a necessary application and various settings; a program for determining, upon reception of a distribution request from the terminal side, whether the required application can be distributed to the terminal side according to the credit balance information extracted from third storage unit 123; a program for selecting and sending a sub-application stored in first storage unit 121 based on a next application ID received from the terminal; a program for storing the application utilization history and others received from the terminal in third storage unit 123; and a program for extracting the application utilization history of a user from third storage unit 123 and, based on the extracted information, extracting appropriate advertisement data and others from first storage unit 121 to send to the relevant user.

The main program may be prestored within the main program storage unit, or it may be recorded in a removable recording medium 111 such as a CD-ROM.

If the program is recorded in the removable recording medium, the recorded program is read from the recording medium by, e.g., a CD-ROM drive, not shown in FIG. 2, and temporarily stored in the main program storage unit.

Examples of such recording mediums for recording programs therein are: tape-type mediums like magnetic tape and cassette tape; disc-type mediums like magnetic discs (flexible disc, hard disk device and others) and optical discs (CD-ROM, MO, MD, DVD and others); card-type mediums like IC card (including memory card) and optical card; and semiconductor memories like mask ROM, EPROM, EEPROM and flash ROM. They carry the programs in a fixed manner.

The recording medium may be of the type that carries the program in a flexible manner, as in the case where the program is downloaded from a network. In such a case, a program for use in the downloading is prestored in server system 100 or pre-installed in server system 100 from another recording medium.

The recording medium may store, not only the program, but also data.

How the main program is executed will be described later, giving a specific example.

Now, terminal devices 200, 210, 220 shown in FIG. 1 will be described in brief. As these devices are identical in primary functional configuration, mobile terminal 200 will be explained representatively.

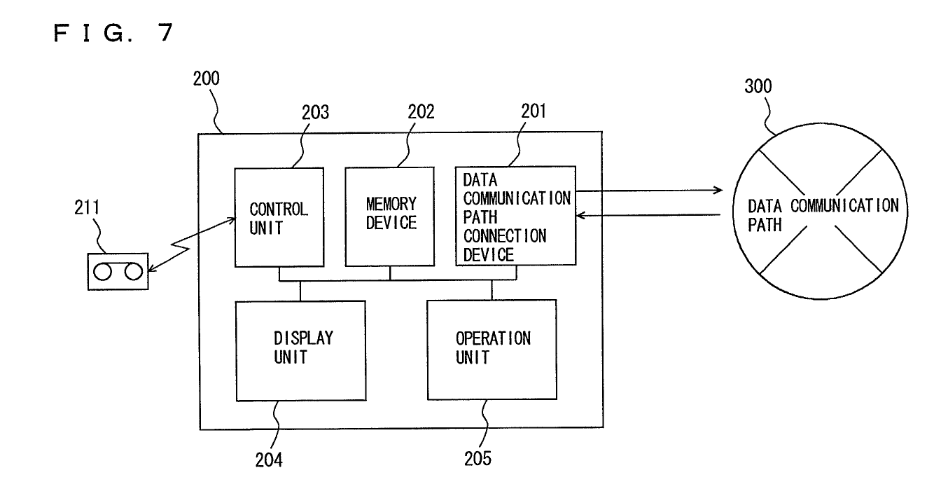

FIG. 7 is a block diagram showing a schematic configuration of mobile terminal 200. Referring to FIG. 7, mobile terminal 200 is provided with a data communication path connection device 201, a memory device 202, a control unit 203, a display unit 204 and an operation unit 205.

Data communication path connection device 201 connects mobile terminal 200 to data communication path 300 and performs bi-directional communication with server system 100 via data communication path 300.

Memory device 202 stores data sent from server system 100, e.g., a sub-application sent in response to a send request.

Control unit 203 is provided with a central processing unit and a main program storage unit, not shown. It controls data communication path connection device 201, memory device 202, display unit 204 and control unit 205, according to the main program stored.

For example, control unit 203 controls sending/receiving of data to/from memory device 202 for execution of a sub-application stored in memory device 202. Upon execution of the sub-application, it controls display unit 204 and operation unit 205 serving as user interfaces. To request a sub-application that is supposed to be required next, control unit 203 also controls the operation of data communication path connection device 201 so as to send the relevant application ID to server system 100.

The main program may be prestored in the main program storage unit, or may be recorded in a removable recording medium 211 like a magnetic tape. As this recording medium 211, again, those described above in conjunction with FIG. 2 may be employed.

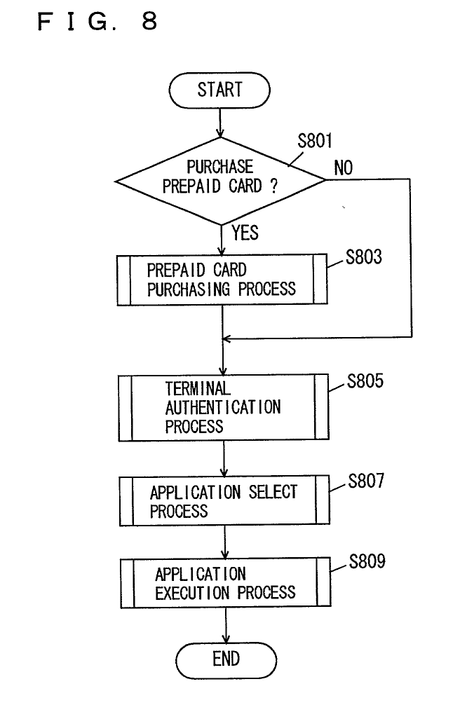

A process flow of the application communication system having the configuration as described above will now be described in detail with reference to FIGS. 8-16.

FIG. 8 is a flow chart illustrating the process flow of the entire application communication system according to the present embodiment. Described herein is the case where a prepaid card is used as a medium of payment for a price of application. Mobile terminal 200 is taken as an example of the terminal device.

Referring to FIG. 8, if a user who wants distribution of an application purchases a prepaid card (“yes” in step S801), control goes to step S803, wherein a prepaid card purchasing process is conducted.

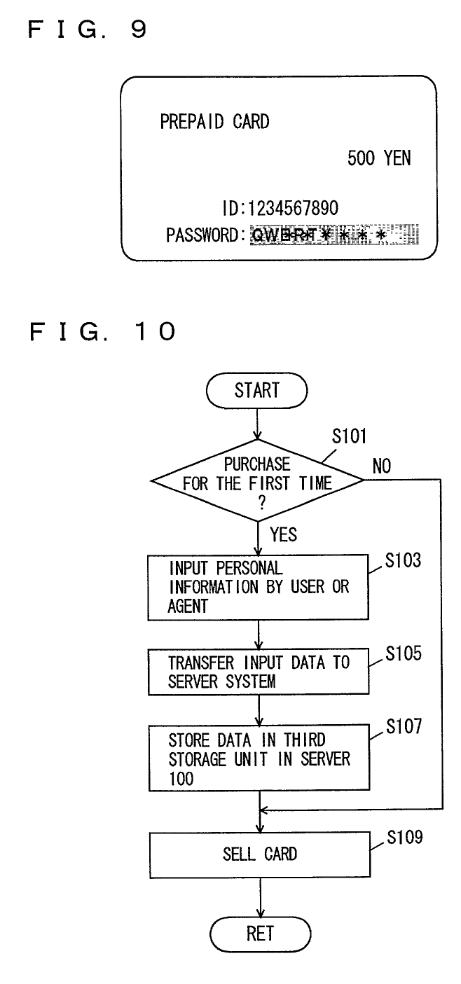

FIG. 9 shows an example of the prepaid card being purchased. As shown in FIG. 9, prepaid ID, password for the prepaid card, value information, date of issuance and others are written on the prepaid card. Thus, the user who purchased the prepaid card by paying a desired sum can read the ID and the password given in advance to the card. Such information about the prepaid card is already registered in fourth storage unit 124 of server system 100.

If the user does not purchase the prepaid card, step S803 is skipped, and control goes to step S805.

In step S805, the user terminal and the server system are connected to each other, and the user information is examined. More specifically, an authentication process of the user information sent from mobile terminal 200 is performed based on the user information stored in third storage unit 123 of server system 100.

Next, in step S807, a select process of desired application is performed. More specifically, a sub-application is distributed and payment is made for the price of the sub-application.

When distribution of the desired application is completed, the distributed application is executed on the user terminal side in step S809. If necessary, a next sub-application is distributed, which is also executed.

The process flow of the entire application communication system has roughly been described. Hereinafter, each process will be described in detail.

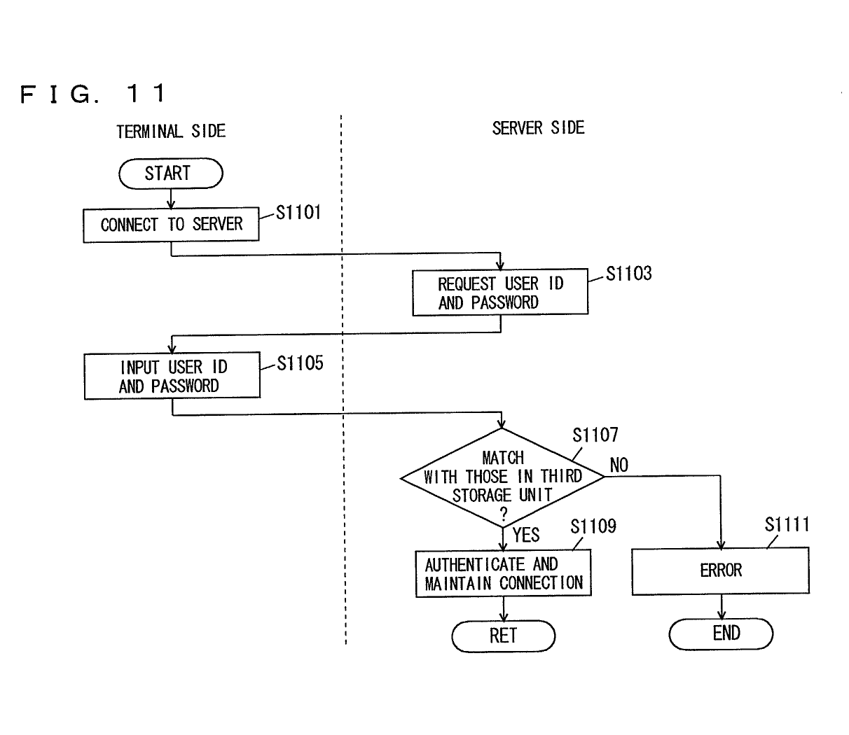

FIG. 10 is a flow chart illustrating a sub-routine for the prepaid card purchasing process (step S803) in FIG. 8. The user purchases the prepaid card as shown in FIG. 9 at a convenience store, a toyshop, a bookstore or the like.

Referring to FIG. 10, if it is the first time that the user purchases a prepaid card, i.e., if the user connects to server system 100 for the first time (“yes” in step S101), personal information of the user and others are input in step S103. More specifically, the user or his/her agent uses a dedicated terminal to input user ID, password, personal information and others.

Then, in step S105, the input personal information and others are sent via data communication path 300 to server system 100. In step S107, server system 100 receives and stores the personal information and others (user ID, password, personal information and others) in third storage unit 123.

After the transfer of data including the personal information, the prepaid card is sold to the user in step S109. The sub-routine is completed, and control returns to the main routine in FIG. 8.

FIG. 11 is a flow chart illustrating a sub-routine for the terminal authentication process (step S805) in FIG. 8. Referring to FIG. 11, first in step S1101, the user connects to server system 100 by mobile terminal 200 with which an application can be utilized. Connection to server system 100 can be made by a mobile terminal 200 that has a function to automatically connect to server system 100.

When the connection is established, in step S1103, server system 100 sends to mobile terminal 200 a request for input of user ID, password and others. In step S105, mobile terminal 200 that received the request displays an input request image plane on display unit 204 to prompt user input. The user inputs data including user ID and password from operation unit 205, following the directions on the image plane. The input data are transferred to server system 100. Data input at this time is not limited to manual input from operation unit 205. For example, the user ID, password and others may be prestored in mobile terminal 200, and they may be used for transmission.

In step SI 107, server system 100 compares the received user ID and password with those stored in third storage unit 123 to determine whether the user is legitimate.

If the user is unauthorized (“no” in step S1107), an error is identified in step S1111, and mobile terminal 200 is prohibited from proceeding to the subsequent step.

If the user is authorized (“yes” in step S1107), the connection between mobile terminal 200 and server system 100 is maintained (step S1109), and the terminal authentication process is completed.

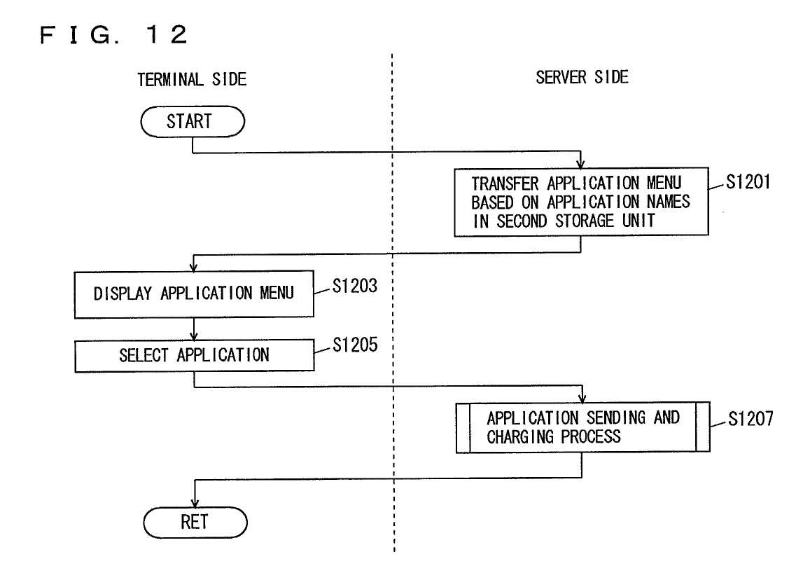

FIG. 12 is a flow chart illustrating a sub-routine for the application select process (step S807) in FIG. 8. Referring to FIG. 12, in step S1201, server system 100 sends a menu of applications to mobile terminal 200 based on the application names stored in second storage unit 122.

Mobile terminal 200 receives and displays the application menu on display unit 204 (step S1203). The user selects a desired application from the menu displayed (step S1205). Information about the selected application is sent to server system 100. Here, assume that a golf game has been selected as the application.

In step S1207, server system 100 that received the information of the selected application sends the relevant application and charges therefor.

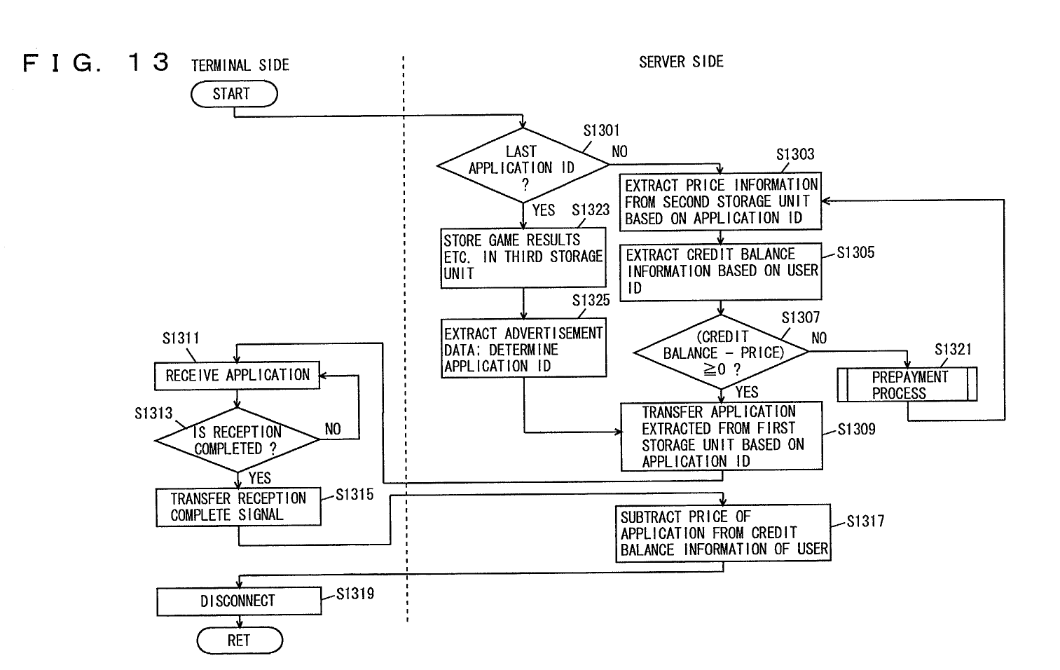

FIG. 13 is a flow chart illustrating a sub-routine for the application sending and charging process (step S1207) in FIG. 12. Referring to FIG. 13, first, in step S1301, server system 100 determines whether the selected sub-application, i.e., the object of the send request, includes the application ID identifying that it is the last sub-application.

If not, control goes to step S1303. In step S1303, control unit 110 extracts, based on the application name (or application ID) received, price information of the relevant sub-application from second storage unit 122.

This time, it is assumed that the application name “Golf Game” is received. This application of “Golf Game” has been divided into n sub-applications, and application ID of the first sub-application is extracted. The price information is extracted from second storage unit 122 based on this application ID.

When the price information of the sub-application to be sent is extracted, next in step S1305, the credit balance information corresponding to the relevant user ID is extracted from third storage unit 123. In step S1307, comparison is made between the price information of the sub-application and the credit balance information corresponding to the user ID.

As a result of comparison, if (credit balance—price)≧0 (“yes” in step S1307), the relevant sub-application is transferred in step S1309. More specifically, the sub-application stored in first storage unit 121 that corresponds to the application ID in second storage unit 122 is read out and transferred to mobile terminal 200.

If (credit balance—price)<0 (“no” in step S1307), the prepayment process is conducted in step S1321.

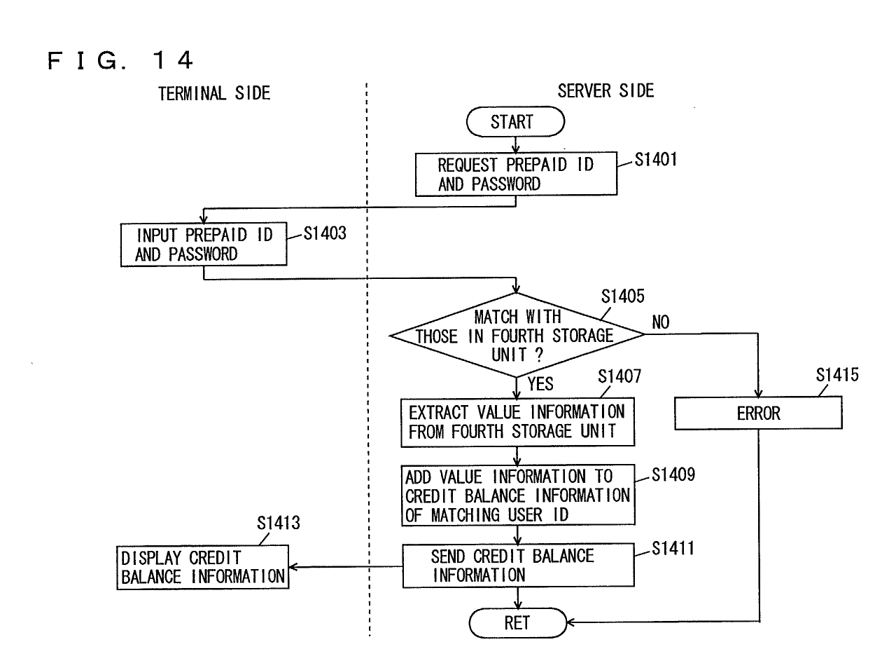

FIG. 14 is a flow chart illustrating a sub-routine of this prepayment process (step S1321 in FIG. 13). Referring to FIG. 14, in step S1401, an input request for prepaid ID, password for the prepaid card and others is sent from server system 100 to mobile terminal 200.

In S1403, mobile terminal 200 that received the input request displays an input request image plane on display unit 204 to prompt user input. The user follows the directions on the screen and inputs data including prepaid ID and password from a keyboard or the like. The input data are transferred from mobile terminal 200 to server system 100. The user may directly input the data using a keyboard and others. Alternatively, a prepaid card may be utilized if it is an IC card or a magnetic card and the terminal is provided with a reading function.

In receipt of the prepaid ID and others, server system 100 checks the received data in step S1405. More specifically, it compares the received data with the prepaid ID and password for the prepaid card stored in fourth storage unit 124, for authentication of the relevant prepaid card.

As a result of comparison, if it is determined that the prepaid card is unauthorized (“no” in step S1405), an error is identified in step S1415, and the user is notified of foulness and prohibited from proceeding to the subsequent step.

As a result of comparison, if it is determined that the card is legitimate (“yes” in step S1405), in step S1407, the value information corresponding to the prepaid ID is extracted from fourth storage unit 124. In step S1409, the extracted value information is added to the credit balance information in third storage unit 123. At this time, “used” is recorded as the utilization information in fourth storage unit 124.

Next, in step S1411, the credit balance information after the value information was added thereto is sent from server system 100 to mobile terminal 200 to notify the user. In mobile terminal 200, the received credit balance information is displayed on display unit 204 in step S1413.

When the prepayment process is thus completed, control returns to step S1307 in FIG. 13. In step S1307, the current credit balance information, i.e., the credit balance information to which the value information of prepaid card has been added, is compared with the price information of the desired sub-application. Control then goes to the prepayment process in step S1321, or to the transfer process of the relevant sub-application in step S1309, according to the comparison result.

When the relevant sub-application is sent from first storage unit 121 to mobile terminal 200 in step S1309, mobile terminal 200 receives it in step S1311.

When the reception of the sub-application is completed (“yes” in step S1313), mobile terminal 200 sends a reception complete signal to server system 100 in step S1315.

Upon receipt of this reception complete signal, in server system 100, the price information associated with the application ID stored in second storage unit 122 is subtracted from the credit balance information corresponding to the user ID stored in third storage unit 123 in step S1317. It means that the user terminal makes payment for the sub-application only after the reception of the sub-application is completed. The result after the subtraction is recorded as the corresponding credit balance information.

When the payment is completed, mobile terminal 200 disconnects with server system 100 in step S1319. The application sending and charging process is thus completed.

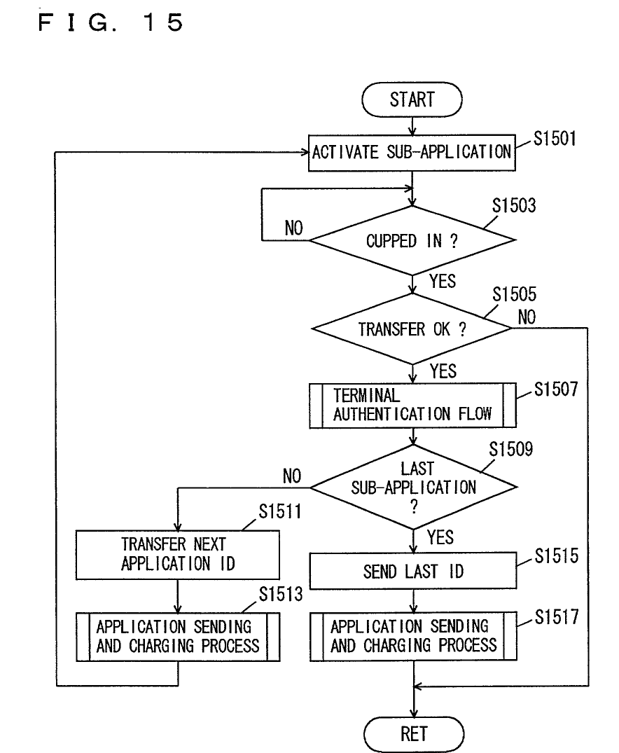

FIG. 15 is a flow chart illustrating a sub-routine for the application execution process (step S809) in FIG. 8. Referring to FIG. 15, first, in step S1501, the application received in response to the request is activated in mobile terminal 200.

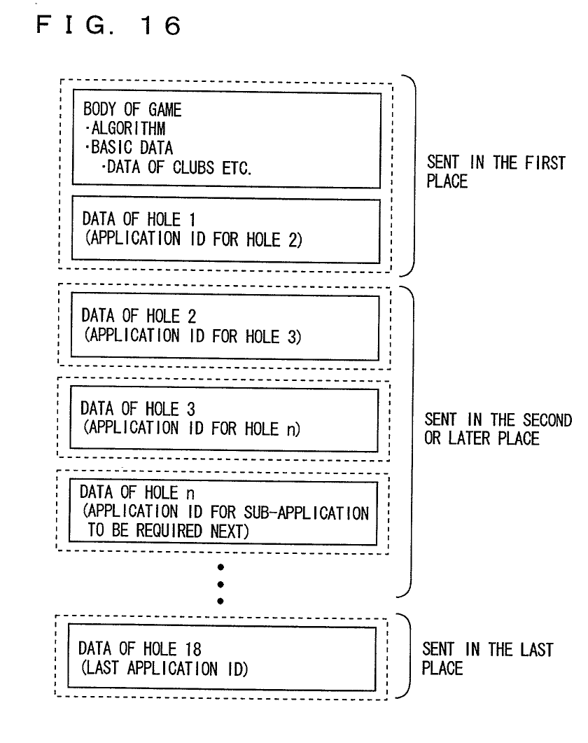

Here, the application of interest is assumed to be the golf game. FIG. 16 shows a configuration of the golf game to be executed. Referring to FIG. 16, this golf game is divided into sub-applications corresponding to respective holes from Hole 1 to Hole 18.

The contents of the golf game to be transferred to mobile terminal 200 in the first place include the basic information of the golf game (i.e., basic program and information of the golf game) and data for Hole 1. The contents of the golf game to be transferred to mobile terminal 200 in the second or later place include just the data for respective holes, the basic information of the golf game being not included therein.

Here, it is configured such that the basic program is included within the contents being sent in the first place. However, it does not exclude the possibility that the basic program is included within the contents being sent in the second or later place.

Each sub-application includes the application ID of a sub-application that is expected to be utilized next.

Returning to FIG. 15, when the golf game is used for the first time, the sub-application sent in the first place is activated. Thus, the golf game of Hole 1 is executed. When cupped in and the play of Hole 1 is finished (“yes” in step S1503), in step S1505, it is determined whether the next sub-application can be transferred. More specifically, it is determined whether the user wants the next sub-application to be transferred or not.

If the transfer is possible (“yes” in step S1505), control goes to step S1507, and mobile terminal 200 is connected to server system 100. That is, the terminal authentication process shown in FIG. 11 is performed again. If the transfer is impossible (“no” in step S1505), mobile terminal 200 is not connected to server system 100, and the game is terminated.

When connection to server system 100 is established according to the terminal authentication process in FIG. 11, mobile terminal 200 determines, in step S1509, whether the sub-application currently cupped in is the last sub-application.

This determination is made based on the application ID indicating a sub-application to be utilized next, which is included in each sub-application. If the relevant application ID is not the one identifying that it is the last sub-application (“no” in step S1509), control goes to step S1511. If the application ID is the one that identifies that it is the last sub-application (“yes” in step S1509), control goes to step S1515.

If it is not the last application, the application ID indicating the next sub-application is transferred from mobile terminal 200 to server system 100 in step S1511. In step S1513, the application sending and charging process shown in FIG. 13 is performed again.

In this case, the determination is made as “no” in decision step S1301 in FIG. 13, and therefore, step S1303 and succeeding steps are repeated. More specifically, the procedures as in the case of Hole 1 are repeated for Hole 2 through Hole 17.

Returning to FIG. 15, if it is the last application, i.e., when Hole 18 is cupped in, the application ID identifying that it is the last sub-application is transferred from mobile terminal 200 to server system 100 in step S1515. At this time, the game results and the like are transferred together. In step S1517, the application sending and charging process as shown in FIG. 13 is performed again.

In this case, as the determination is made as “yes” in decision step S1301 in FIG. 13, step S1323 and succeeding steps are performed. More specifically, in step S1323, server system 100 records the application ID identifying that it is the last sub-application, the game results and others, as the application utilization history information in third storage unit 123.

Then, in step S1325, server system 100 extracts appropriate advertisement data and others from first storage unit 121, referring to the utilization history information stored in third storage unit 123. The advertisement data and others thus extracted are sent from server system 100 to mobile terminal 200.

According to the process flow of the application communication system as described above, an application to be communicated is divided into a plurality of sub-applications, and only necessary sub-applications are sent/received in one communication. Further, at least the sub-application being sent in the first place is executable alone. Thus, the user is able to execute the sub-application immediately after he/she received it. Accordingly, it becomes possible to execute the application in an extremely short period of time after the user issued the send request.

In addition, the communication cost that is required for starting the execution of a desired application is reduced. The user is allowed to execute a part of the application and, thereafter, to decide whether he/she wants to execute the remaining sub-application(s) continuously. This broadens the user's options, and also avoids the conventional inconvenience that the entire application should always be sent regardless of the user's wish.

Further, since the data capacity being sent at one time is small, the traffic load on the communication line is reduced. Since the sub-application can be executed alone, the storage capacity required for the terminal device is also reduced.

Payment for the transferred application is demanded, not for the entire application, but for each sub-application. Accordingly, the user is charged only for the sub-application(s) he/she needs. This makes it possible to utilize an application at a minimum price.

Moreover, the payment is demanded after the transfer of sub-application is completed, even for a terminal whose communication condition is unstable like mobile terminal 200. Accordingly, the user of such terminal is able to make a send request for an application without anxiety.

Still further, the prepayment information of a prepaid card or the like is managed on server system 100 side, along with the credit balance information of the relevant user, which cannot be tampered with. Thus, the credibility of the application communication system itself is improved, ensuring smooth operation of the system.

In the configuration of the golf game shown in FIG. 16, the application is divided into sub-applications corresponding to respective holes. However, the configuration is not limited thereto. For example, the application may further be divided according to the ways to address balls, e.g., in the bunker, in the pond, and out of bounds in respective holes, and these sub-applications may be transferred to a terminal when necessary.

Although the golf game has been given as an example of the application in FIGS. 15 and 16, the present embodiment is not limited thereto. For example, the present embodiment can be applied to the case where book data of a novel is divided into respective chapters like Chapter 1, Chapter 2 and others, or to the case where a demo program is divided into respective steps along the order of demonstration. In other words, the present invention can be applied to any application whose sub-applications have a specific order for execution and whose object can be achieved by executing the sub-applications in the order.

In FIG. 15 and others, the case where the sub-applications of the golf game are executed in order from Hole 1 to Hole 18 has been described. However, the present invention is not limited thereto. Some application may allow a change in the order of execution of its sub-applications, depending on the contents. Another application may be finished, with its object being achieved, before all the sub-applications are executed. The present invention is also applicable to such cases.

Further, in the present embodiment, one sub-application has been defined as the communication unit of one communication. However, upon the user's request, two or more sub-applications may be communicated at one time.

In FIG. 13 and others, the case where payment is demanded (made) for each sub-application has been described. However, the price for the entire application, i.e., for all the n sub-applications 1-n may be charged (paid) in a lump.

In the present embodiment, the case where the price of the supplied application is paid by the prepaid card has been described. However, the medium of payment is not limited to the prepaid card. It may be charged to the user's bank account, or a debit card may be utilized. It may be paid later on demand, or any other charging (payment) method can be employed.

First Modification

The first modification of the first embodiment will now be described. The first modification differs from the first embodiment in that the price of each sub-application is set according to its order of transfer. More specifically, in the present modification, the price of sub-application being sent in the second or later place is set lower than the price of sub-application being sent in the first place.

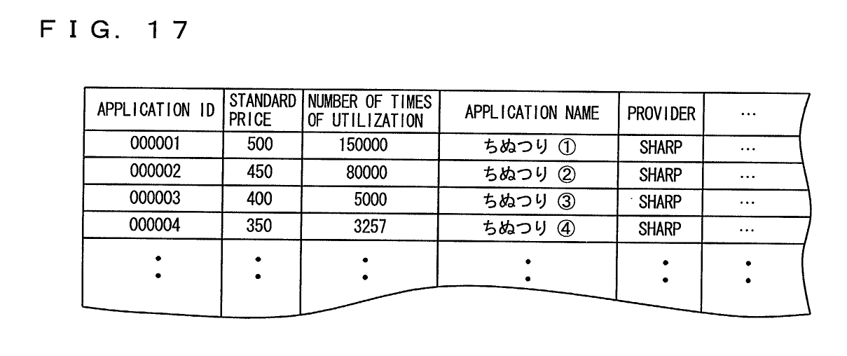

FIG. 17 shows an example of data being stored in second storage unit 122 in the first modification. Referring to FIG. 17, second storage unit 122 stores standard price, number of times of utilization, application name, name of provider and others, corresponding to each application ID.

Here, a sub-application ( [symbol] \mathring{1}) having application ID 000001 corresponds to the one to be transferred in the first place among all the sub-applications constituting the application named “ [symbol] ”. Therefore, compared to the standard price (500 yen) of this sub-application, the standard prices of sub-applications (having application IDs 000002, 000003 and others) that are being transferred in the second place and afterward are set lower.

Further, in FIG. 17, it is configured such that the price becomes increasingly lower as the number of transferred sub-applications increases. More specifically, the standard price is set at 500 yen for the application ID 000001; 450 yen for application ID 000002; 400 yen for application ID 000003; and 360 yen for application ID 000004, and so on. The standard prices of the sub-applications are thus set according to their order of transfer.

The charging process against the user is performed based on the standard price information shown in FIG. 17. Accordingly, in the flow chart illustrating the charging process in FIG. 13, the “price information” in step S1303 is considered as the “standard price” shown in FIG. 17.

That is, the user is charged using the “price information that is lower for a sub-application being transferred in the second or later place than for a sub-application being transferred in the first place”.

Accordingly, it becomes possible to give the user who received the first sub-application an incentive to purchase and utilize the following sub-application(s).

Second Modification

In the first modification, the standard prices of the sub-applications being sent in the second place and afterward have been set lower than that of the sub-application being sent in the first place. In the second modification, the price information of a sub-application that is to be transferred next is set, regardless of the order of transfer, based on the number of times of utilization of its preceding sub-application and a discount rate corresponding to that number of utilization.

Here, the numbers of times of utilization of respective sub-applications are stored in second storage unit 122, as shown in FIG. 17. The discount rates corresponding to these numbers of utilization are stored in a fifth storage unit 125. Thus, in the present modification, storage unit 120 shown in FIGS. 1 and 2 is further provided with the fifth storage unit 125.

FIG. 18 shows an example of data being stored in fifth storage unit 125. Referring to FIG. 18, the discount rate is set to 0% when the number of times of utilization of a sub-application is at least 0 and less than 10,000; 10% when it has been utilized at least 10,000 times and less than 100,000 times; and 30% when it has been utilized at least 100,000 times.

The charging process against a user is performed based on the discount rate stored in fifth storage unit 125 and the price information (standard price) stored in second storage unit 122. More specifically, a discount price of sub-application to be transferred next is set according to the discount rate and the standard price, and the charging process is conducted using the discount price.

A specific example of price setting will be described with reference to FIGS. 17 and 18. Referring to FIG. 17, the number of times of utilization of application ID (000001) is 150,000, and the corresponding discount rate is 30% from FIG. 18. Accordingly, the price of application ID (000002) to be transferred next is discounted by 30% from its standard price. Since its standard price is 450 yen, the price to be charged is set to 450 yen*(1−0.3) =315 yen.

Similarly, since the number of times of utilization of application ID (000002) is 80,000, the discount rate for application ID (000003) is 10%. Thus, the discount price of application ID (000003) is set to 400 yen*(1−0.1 =360 yen.

The number of times of utilization of application ID (000003) is 5,000, and the discount rate for application ID (000004) is 0%. Thus, the price of application ID (000004) is set to 360 yen *(1−0)=360 yen.

The prices of respective sub-applications are thus set. Accordingly, in the flow chart illustrating the charging process in FIG. 13, the “price information” being extracted in step S1303 is defined as the “price information of sub-application to be transferred next that is set based on the number of times of utilization of its preceding sub-application, which is stored in second storage unit 122, and the discount rate corresponding to that number of utilization, which is stored in fifth storage unit 125”.

The discount rate being stored in fifth storage unit 125 is set based on the numbers of times of utilization of respective sub-applications by a provider of the application at its own discretion.

According to the present modification, a discount is made off the standard price of sub-application to be transferred next, based on the number of times of utilization of its preceding sub-application stored in second storage unit 122 and the corresponding discount rate stored in fifth storage unit 125. Therefore, a popular application can be purchased at a lower price, which can arouse an incentive of a user to buy and use the application.

Here, the data of the type as shown in FIG. 17 has been considered to be stored in second storage unit 122. However, the present modification may also be configured to utilize the price information that has been set regardless of the order of transfer of sub-applications, as shown in FIG. 4. In this case, the price to be charged is determined according to the price information and the discount rate.

Third Modification

In the second modification, the price of sub-application to be transferred next has been set based on the number of times of utilization of its preceding sub-application stored in second storage unit 122 and the discount rate corresponding to that number of utilization stored in fifth storage unit 125. In the present modification, the prices of sub-applications being sent in the second place and afterward are set based on the number of times of utilization of the sub-application that is sent in the first place and the discount rate corresponding to that number of utilization.

Here, again, the numbers of times of utilization of respective sub-applications are stored in second storage unit 122 as shown in FIG. 17. The discount rates corresponding to the numbers of utilization are stored in fifth storage unit 125 as shown in FIG. 18. Thus, according to the present modification, again, storage unit 120 shown in FIGS. 1 and 2 is further provided with the fifth storage unit 125.

The charging process against a user is conducted based on the discount rates stored in this fifth storage unit 125 and the price information (standard prices) stored in second storage unit 122. More specifically, using the discount rate that is determined according to the number of times of utilization of the sub-application being sent in the first place, the prices of the sub-applications being sent in the second place and afterward are set, and the charging process is performed using these discount prices.

Hereinafter, the detailed procedures will be described with reference to FIGS. 17 and 18. Referring to FIG. 17, since the number of times of utilization of application ID (000001) is 150,000, the discount rate is 30% from FIG. 18. Thus, the prices of the sub-applications being sent in the second place and afterward are discounted by 30% from their respective standard prices.

For example, in the case of application ID (000002) whose standard price is 450 yen, the price being charged is set to 450 yen*(1−0.3)=315 yen.

Similarly, for application ID (000003) whose standard price is 400 yen, the price being charged is set to 400 yen*(1−0.3)=280 yen.

For application ID (000004), 360 yen*(1−0.3)=245 yen is being charged.

The prices of respective sub-applications are thus set. Accordingly, in the flow chart illustrating the charging process in FIG. 13, the “price information” being extracted in step S1303 is defined as the “price information of sub-application being sent in the second or later place that is set based on the number of times of utilization of sub-application being sent in the first place, which is stored in second storage unit 122, and the corresponding discount rate, which is stored in fifth storage unit 125”.

The discount rates being stored in fifth storage unit 125 are set based on the number of times of utilization of the sub-application that is sent in the first place, at a discretion of a provider of the application.

According to the present modification, the prices of sub-applications being sent in the second place and afterward are discounted based on the number of times of utilization of the sub-application being sent in the first place and the corresponding discount rate. Thus, a user can purchase a popular application at a lower price. Accordingly, it is possible to give a user who received the first sub-application an incentive to buy or use the following sub-application(s).

Here, again, the data shown in FIG. 17 has been employed as the exemplary data stored in second storage unit 122. However, the price information of sub-applications being set irreverent to their transfer order as shown in FIG. 4 may be used instead. In this case, the price to be charged is determined according to the price information and the discount rate.

(2) Second Embodiment

Hereinafter, the second embodiment of the present invention will be described. The application communication system of the present embodiment has a configuration identical to that of the first embodiment. The server system of the present embodiment also has a configuration as shown in FIG. 2.

The present embodiment, however, differs from the first embodiment in the following points. First, second storage unit 122 stores information about presence/absence of advertisement and price after prescribed discount based on the presence/absence of advertisement, for each sub-application. In the case where a sub-application having advertisement corresponding thereto is being transferred, the sub-application with the advertisement that is stored in first storage unit 121 is transferred. For the sub-application having the advertisement, the charging process is performed using the price information after prescribed discount that is stored in second storage unit 122. Finally, each application ID stored in first storage unit 121 has its last bit indicating presence/absence of advertisement corresponding thereto.

FIG. 19 shows an example of data stored in second storage unit 122 according to the second embodiment. Referring to FIG. 19, second storage unit 122 stores standard price, number of times of utilization, application name, name of provider and others for each sub-application, as in the case of the first embodiment shown in FIG. 4. In addition thereto, it also stores information about presence/absence of advertisement and discount price.

For a sub-application indicated to have advertisement corresponding thereto, an appropriate discount is made and the discount price is stored. For example, for application ID (123456a) having advertisement, 200 yen is deducted from the standard price, and 300 yen is set as its discount price. For application ID (123457a), 150 yen is deducted from the standard price to obtain a discount price of 250 yen. For application ID (123458a), 150 yen is again deducted from the standard price and the discount price is set to 250 yen.

The prices to be deducted are set as desired by the application provider and the sponsor of the advertisement data. If there are more than one sponsor of advertisement, the discount prices may be set still lower.

The charging process against a user is performed based on the price information (standard prices or discount prices) thus set. More specifically, in the case where “yes” is indicated in the column of “advertisement”, the charging process is conducted using the discount price, and if “no” is indicated in the column of “advertisement”, the standard price is used for the charging process.

When a sub-application indicated as “yes” in the column of “advertisement” is to be sent, the sub-application with advertisement data that is stored in first storage unit 121 is sent. Thus, in this case, the terminal which issued the send request receives the sub-application with the advertisement data attached thereto.

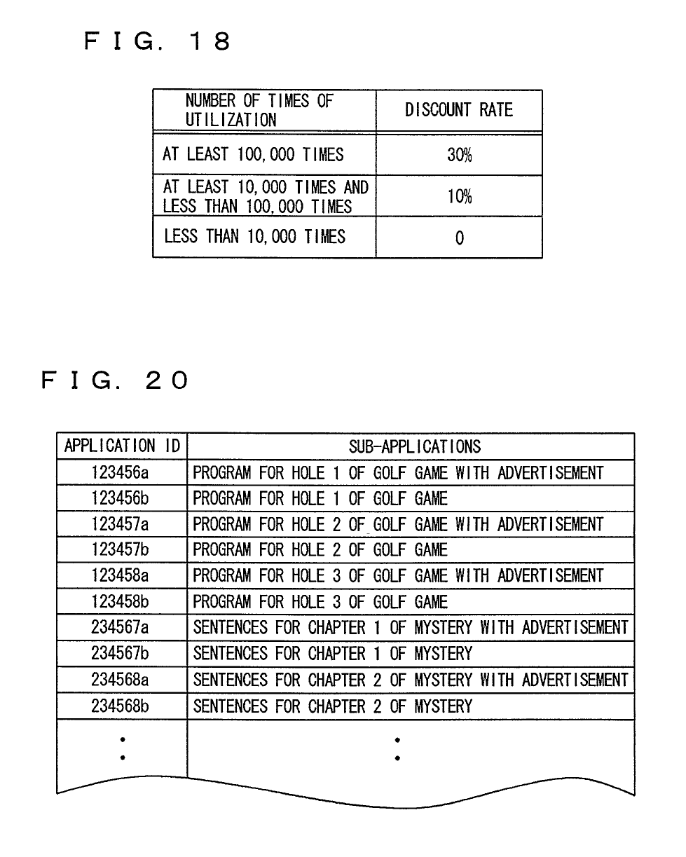

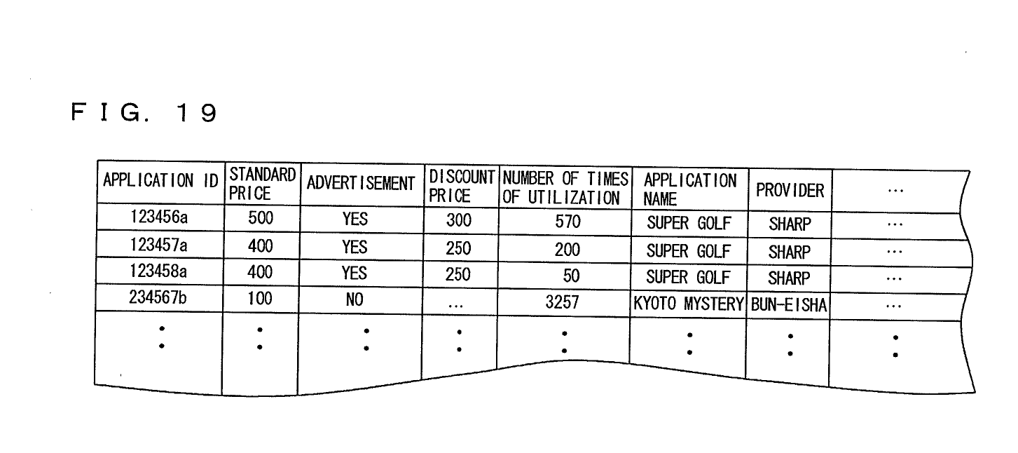

FIG. 20 shows an example of data being stored in first storage unit 121 in the present embodiment. As shown in FIG. 20, each sub-application ID is provided with “a” as its last bit when there is an advertisement, and provided with “b” when there is no advertisement.

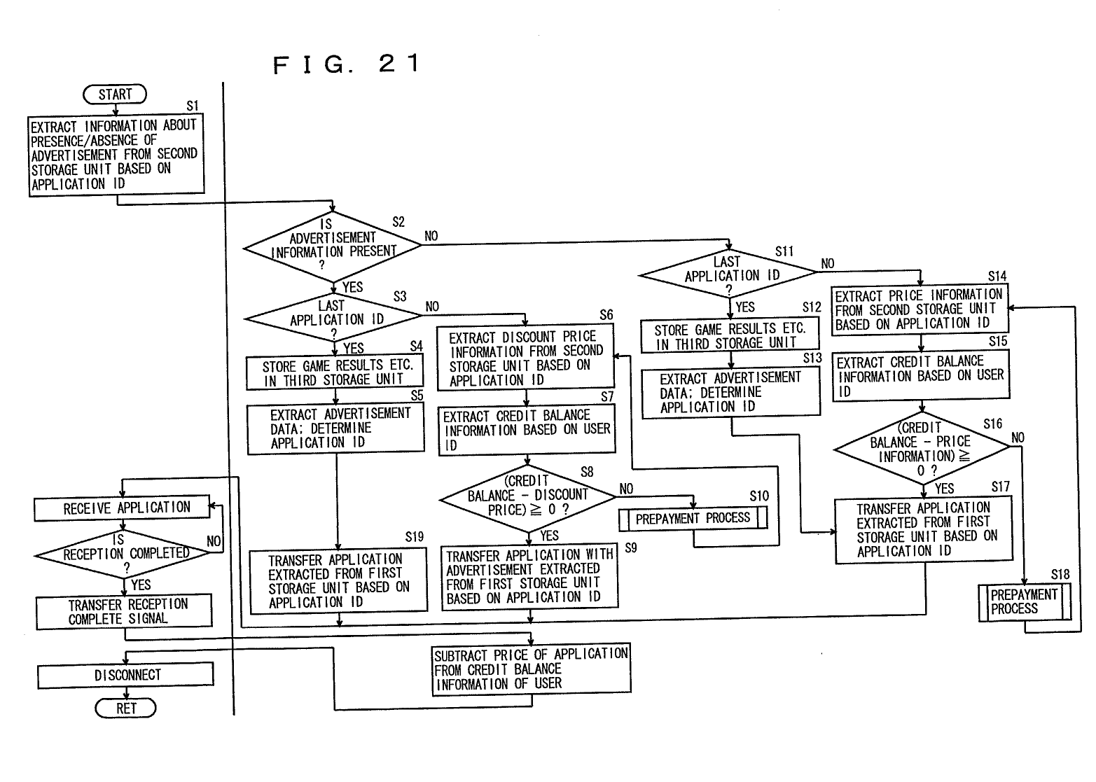

A flow of the application sending and charging process (step S1207 in FIG. 12) in the case of the present embodiment will now be described with reference to FIG. 21. FIG. 21 corresponds to the flow chart of FIG. 13 in the first embodiment. Thus, only the differences therebetween will primarily be described.

First, in step S1, information about presence/absence of advertisement for a corresponding application ID is extracted from second storage unit 122. If the advertisement information is present (“yes” in step S2), steps S3-S10 are performed. If there is no advertisement (“no” in step S2), steps S11-S18 are performed.

In the case where the advertisement is present and the relevant sub-application has an application ID identifying that it is the last sub-application (“yes” in step S3), the game results and others are stored in third storage unit 123 in step S4. Next, in step S5, the advertisement data is extracted, and the application ID is determined. In step S19, a sub-application extracted from first storage unit 121 based on this application ID is transferred.

If the application ID of the relevant sub-application is not the one identifying that it is the last application (“no” in step S3), the discount price information is extracted from second storage unit 122 based on the application ID in step S6. Next, in step S7, the credit balance information is extracted based on the user ID, and in step S8, a comparison is made between the credit balance information and the discount price information.

As a result of the comparison, if (credit balance—discount price)>0, the sub-application with advertisement data is transferred from the server system to the terminal in step S9.

On the contrary, if (credit balance—price after prescribed discount) <0, the prepayment process is conducted in step S10.

If there is no advertisement (“no” in step S2), the application sending and charging process identical to that in the first embodiment is performed (steps S11-S18).

As explained above, according to the present embodiment, if a sub-application has advertisement corresponding thereto, the application provider charges a user a price after prescribed discount, and collects the difference from the sponsor of the advertisement.

Accordingly, from the standpoint of a user receiving the application, he/she is able to purchase the sub-application at a low price. Further, since related advertisement data is sent at the same time, the user can receive latest information that would attract his/her interest.

From the standpoint of a sponsor of advertisement, he/she is able to advertise as desired by providing the user with the latest information of, e.g., a new application.

If the advertisement of the latest information about a new application or the like is made via printed matters or storage mediums, time lag of several weeks usually occurs until they are distributed, so that the freshness thereof tends to be lost. This poses a serious problem in terms of capturing users. Further, the advertisement should be distributed even to those having no interest therein, which is wasteful for both the sponsor and receivers of the advertisement.

According to the present embodiment, a sub-application with advertisement is transferred only when a sub-application that is indicated as having advertisement is being transferred. This enables advertisement with a minimum advertisement rate. Accordingly, the present embodiment proposes an advantage that even a person who runs a small-scale business, e.g. a private developer of game software, is able to publish advertisement data.

Further, according to the present embodiment, the application communication system allows participation of sponsors of advertisement, besides application providers and users between which applications are communicated. Therefore, the application providers, the users and the sponsors of advertisement are all activated.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A server device, comprising:
a first storage unit storing an application divided into a plurality of sub-applications;
a receiving unit receiving information from a user; and
a sending unit sending at least one of said sub-applications according to said information received,
at least one of said sub-applications being executable alone.

2. The server device according to claim 1, wherein said sending unit first sends the sub-application that is executable alone.

3. The server device according to claim 1, wherein said sub-applications have their order for execution, and an object of the application before being divided is achieved by executing said sub-applications in said order.

4. The server device according to claim 1, wherein said first storage unit stores said sub-applications by relating them with IDs for identification thereof.

5. The server device according to claim 4, wherein said sub-application includes the ID of the sub-application that is to be utilized next.

6. The server device according to claim 4, wherein at least one of said sub-applications includes the ID that identifies that the relevant sub-application is the last one.

7. The server device according to claim 4, wherein when said receiving unit receives the ID of said sub-application, said sending unit sends, based on said ID received, the relevant sub-application stored in said first storage unit.

8. The server device according to claim 1, further comprising a second storage unit storing prescribed information for each said sub-application.

9. The server device according to claim 8, wherein said prescribed information includes an ID of said sub-application and price information corresponding thereto.

10. The server device according to claim 9, wherein said price information corresponding to said sub-application that is being sent in the second or later place is set lower than said price information corresponding to said sub-application that is being sent in the first place.

11. The server device according to claim 8, wherein said prescribed information includes a number of times of utilization of said sub-application.

12. The server device according to claim 11, further comprising a fifth storage unit storing information of a discount rate corresponding to said number of times of utilization.

13. The server device according to claim 12, further comprising a setting unit setting a price of the sub-application to be transferred next, based on the number of times of utilization of prescribed said sub-application that is stored in said second storage unit and the discount rate corresponding to the relevant number of times of utilization that is stored in said fifth storage unit.

14. The server device according to claim 12, further comprising a setting unit setting a price of the sub-application to be transferred in the second or later place, based on the number of times of utilization of the sub-application being sent in the first place that is stored in said second storage unit and the discount rate corresponding to the relevant number of times of utilization that is stored in said fifth storage unit.

15. The server device according to claim 8, wherein said prescribed information includes information about presence/absence of advertisement.

16. The server device according to claim 15, wherein when the sub-application for which said stored information about presence/absence of advertisement indicates the presence of the advertisement is to be sent, said sending unit sends the relevant sub-application with corresponding advertisement data attached thereto.

17. The server device according to claim 8, wherein said prescribed information includes an application name corresponding to said sub-application.

18. The server device according to claim 1, further comprising a third storage unit storing user information.

19. The server device according to claim 18, wherein said user information includes user ID and password for identification of a user.

20. The server device according to claim 19, further comprising a first determination unit determining, when said receiving unit receives user ID and password, whether said received user ID and password match the user ID and password stored in said third storage unit.

21. The server device according to claim 20, further comprising a prohibition unit prohibiting a sending operation of said sending unit when said first determination unit determines that the user IDs and the passwords mismatch.

22. The server device according to claim 18, wherein said user information includes an application utilization history.

23. The server device according to claim 22, further comprising:
an extract unit extracting appropriate advertisement data stored in said first storage unit based on said utilization history stored; and
an advertisement data sending unit sending said advertisement data extracted.

24. The server device according to claim 18, wherein said user information includes credit balance information of a user.

25. The server device according to claim 24, further comprising a comparison unit comparing said credit balance information of a user and price information of the sub-application required by the user,
wherein said sending unit sends said sub-application when said comparison unit determines that said credit balance information is at least equal to said price information.

26. The server device according to claim 1, further comprising a fourth storage unit storing prepayment information.

27. The server device according to claim 26, wherein said prepayment information includes prepaid ID and password.

28. The server device according to claim 27, further comprising a second determination unit determining, when said receiving unit receives prepaid ID and password, whether said received prepaid ID and password match the prepaid ID and password stored in said fourth storage unit.

29. The server device according to claim 26, wherein said prepayment information includes value information.

30. The server device according to claim 1, further comprising a charging unit charging a user a price of said sub-application every time said sending unit sends said sub-application to the user.

31. The server device according to claim 30, further comprising a confirmation unit confirming whether sending of said sub-application from said sending unit is completed,
wherein said charging unit charges for said sub-application when said confirmation unit confirms completion of the sending.

32. A server device, comprising:
a first storage unit storing an application divided into a plurality of sub-applications;
a receiving unit receiving information from a user;
a sending unit sending at least one of said sub-applications according to said information received; and
a charging unit charging a user a price of said sub-application every time said sending unit sends said sub-application to the user.

33. The server device according to claim 32, further comprising a confirmation unit confirming whether sending of said sub-application by said sending unit is completed,
wherein said charging unit charges for said sub-application when completion of the sending is confirmed by said confirmation unit.

34. The server device according to claim 32, further comprising:
a second storage unit storing user ID and password for identification of a user;
a determination unit determining, when said receiving unit receives user ID and password, whether the received user ID and password match the user ID and password stored in said second storage unit; and
a prohibition unit prohibiting a sending operation of said sending unit when said determination unit determines that the user IDs and passwords mismatch.

35. The server device according to claim 34, wherein said second storage unit further stores credit balance information of a user, and
said sending unit sends said sub-application required by the user when said credit balance information is at least equal to price information of the relevant sub-application.

36. A terminal device, comprising:
a receiving unit receiving a sub-application as a portion of a divided application;
an execution unit executing said sub-application received; and
a request unit requesting sending of a next sub-application according to a result of execution of said received sub-application by said execution unit, based on information about the sub-application to be utilized next that is stored in said received sub-application.

37. The terminal device according to claim 36, wherein when advertisement data corresponding to said sub-application is sent along with said sub-application, said receiving unit receives the advertisement data as well.

38. The terminal device according to claim 36, further comprising a sending unit sending a reception complete signal when said receiving unit completes a receiving operation of said sub-application.

39. An application communication system comprising the server device according to claim 1 and the terminal device according to claim 36.

40. An application communication method, comprising:
a first storing step of storing an application divided into a plurality of sub-applications;
a receiving step of receiving information from a user; and
a sending step of sending at least one of said sub-applications according to said received information,
at least one of said sub-applications being executable alone.

41. The application communication method according to claim 40, wherein said sending step includes the step of sending the sub-application executable alone first.

42. The application communication method according to claim 40, wherein said sub-applications have their order for execution, and an object of the application before being divided is achieved by executing said sub-applications in said order.

43. The application communication method according to claim 40, wherein said first storing step includes the step of storing said sub-applications by relating them with IDs for identification thereof.

44. The application communication method according to claim 43, wherein said sub-applications each include the ID of the sub-application that is to be utilized next.

45. The application communication method according to claim 43, wherein at least one of said sub-applications includes the ID indicating that the relevant sub-application is the last one.

46. The application communication method according to claim 43, wherein said sending step includes the step of, when the ID of said sub-application is received in said receiving step, sending the relevant sub-application stored in said first storing step based on said received ID.

47. The application communication method according to claim 40, further comprising a second storing step of storing prescribed information for each said sub-application.

48. The application communication method according to claim 40, wherein said prescribed information includes an ID of said sub-application and price information corresponding thereto.

49. The application communication method according to claim 48, wherein said price information corresponding to said sub-application that is to be sent in the second or later place is lower than said price information corresponding to said sub-application that is being sent in the first place.

50. The application communication method according to claim 47, wherein said prescribed information includes a number of times of utilization of said sub-application.

51. The application communication method according to claim 50, further comprising a fifth storing step of storing information of a discount rate corresponding to said number of times of utilization.

52. The application communication method according to claim 51, further comprising a setting step of setting a price of the sub-application that is to be utilized next, based on the number of times of utilization of prescribed said sub-application that is stored in said second storing step and the discount rate corresponding to the relevant number of times of utilization that is stored in said fifth storing step.

53. The application communication method according to claim 52, further comprising a setting step of setting a price of the sub-application that is to be sent in the second or later place, based on the number of times of utilization of the sub-application being sent in the first place that is stored in said second storing step and the discount rate corresponding to the relevant number of times of utilization that is stored in said fifth storing step.

54. The application communication method according to claim 47, wherein said prescribed information includes information about presence/absence of advertisement.

55. The application communication method according to claim 54, wherein when the sub-application for which said stored information about presence/absence of advertisement indicates the presence of the advertisement is being sent, said sending step includes the step of sending said sub-application with corresponding advertisement data attached thereto.

56. The application communication method according to claim 47, wherein said prescribed information includes an application name corresponding to said sub-application.

57. The application communication method according to claim 40, further comprising a third storing step of storing user information.

58. The application communication method according to claim 57, wherein said user information includes user ID and password for identification of a user.

59. The application communication method according to claim 58, further comprising a first determining step of determining, when user ID and password are received in said receiving step, whether said received user ID and password match the user ID and password stored in said third storing step.

60. The application communication method according to claim 59, further comprising a prohibiting step of prohibiting a sending operation by said sending step when said first determining step determines that the user IDs and passwords mismatch.

61. The application communication method according to claim 57, wherein said user information includes an application utilization history.

62. The application communication method according to claim 61, further comprising:
an extracting step of extracting, based on said utilization history stored, appropriate advertisement data stored in said first storing step; and
an advertisement data sending step of sending said extracted advertisement data.

63. The application communication method according to claim 40, wherein said user information includes credit balance information of a user.

64. The application communication method according to claim 63, further comprising a comparing step of comparing said credit balance information of a user with the price information of a sub-application required by the user,
wherein said sending step includes the step of sending said sub-application if said credit balance information is at least equal to said price information as a result of comparison by said comparing step.

65. The application communication method according to claim 40, further comprising a fourth storing step of storing prepayment information.

66. The application communication method according to claim 65, wherein said prepayment information includes prepaid ID and password.

67. The application communication method according to claim 66, further comprising a second determining step of determining, when prepaid ID and password are received in said receiving step, whether said received prepaid ID and password match the prepaid ID and password stored in said fourth storing step.

68. The application communication method according to claim 65, wherein said prepayment information includes value information.

69. The application communication method according to claim 40, further comprising a charging step of charging a user a price of said sub-application every time said sub-application is sent to the user in said sending step.

70. The application communication method according to claim 69, further comprising a confirming step of confirming whether sending of said sub-application is completed in said sending step,
wherein said charging step includes the step of charging for said sub-application when completion of the sending is confirmed by said confirming step.

71. An application communication method, comprising:
a first storing step of storing an application divided into a plurality of sub-applications;
a receiving step of receiving information from a user;
a sending step of sending at least one of said sub-applications according to said information received; and
a charging step of charging a user a price of said sub-application every time said sub-application is sent to the user in said sending step.

72. The application communication method according to claim 71, further comprising a confirming step of confirming whether sending of said sub-application is completed in said sending step,
wherein said charging step includes the step of charging for said sub-application when completion of the sending is confirmed by said confirming step.

73. The application communication method according to claim 71, further comprising:
a second storing step of storing user ID and password for identification of a user;
a determining step of determining, when user ID and password are received in said receiving step, whether said received user ID and password match the user ID and password stored in said second storing step; and
a prohibiting step of prohibiting a sending operation by said sending step when said determining step determines mismatch of the user IDs and passwords.

74. The application communication method according to claim 73, wherein said second storing step includes the step of further storing credit balance information of a user, and
said sending step includes the step of sending said sub-application required by the user when said credit balance information is at least equal to price information of the relevant sub-application.

75. An application communication method, comprising:
a receiving step of receiving a sub-application as a portion of a divided application;
an executing step of executing said sub-application received; and
a requesting step of issuing a send request for a next sub-application according to a result of execution by said executing step, based on information of the sub-application to be utilized next that is stored in said received sub-application.

76. The application communication method according to claim 75, further comprising a sending step of sending a reception complete signal when a receiving operation of the sub-application is completed in said receiving step.

77. An application communication method performing communication of application using the server device according to claim 1 and the terminal device according to claim 36.

78. An application communication method performing communication of application using the server device according to claim 32 and the terminal device according to claim 36.

79. A recording medium recording an application communication program for causing a computer to perform:
a first storing step of storing an application divided into a plurality of sub-applications;
a receiving step of receiving information from a user; and
a sending step of sending at least one of said sub-applications according to said information received,
at least one of said sub-applications being executable alone.

80. A recording medium recording an application communication program for causing a computer to perform:
a first storing step of storing an application divided into a plurality of sub-applications;
a receiving step of receiving information from a user;
a sending step of sending at least one of said sub-applications according to said information received; and
a charging step of charging a user a price of said sub-application every time said sub-application is sent to the user in said sending step.
